(19) United States
(12) Patent Application Publication
(10) Pub. No.: US 2007/0279541 A1
(43) Pub. Date: Dec. 6, 2007

(54) Method of driving liquid crystal display device

(75) Inventors: Akihiro Mochizuki, Louisville, CO (US); Hajime Ikeda, Kawasaki-shi (JP)

Correspondence Address: MORRISON & FOERSTER LLP, 1650 TYSONS BOULEVARD, SUITE 400, MCLEAN, VA, 22102, US

(73) Assignee: Nano Loa, Inc., Kawasaki-shi (JP)

(21) Appl. No.: 11/168,933

(22) Filed: Jun. 29, 2005

(51) Int. Cl. G02F 1/133

(52) U.S. Cl. 349/36

(57) ABSTRACT

A method of driving a liquid crystal device that comprises at least a pair of substrates and a liquid crystal material disposed between the pair of substrates. A voltage increase rate to be attained during the duration of a voltage pulse applied to the liquid crystal device is changed in order to continuously control the quantity of light transmitted by the liquid crystal device, whereby shades are displayed.

### BACKGROUND OF THE INVENTION

1. Field of the Invention

The present invention relates to a method of driving a liquid-crystal display device. More particularly, the present invention relates to a method of driving a liquid-crystal display device, which is commonly applicable to various high-performance color-rendering methods or so-called full-color display methods for liquid-crystal displays (LCDs) (gray-scale display methods including, for example, an analog gray-scale method and a digital gray-scale method, and coloring techniques including, for example, a color filtering technique or a spatial color display technique, and a time-division coloring technique or a temporal color display technique).

2. Description of the Related Art

The scope of applicable fields for the image display techniques represented by television image display technique has greatly expanded along with the development of the digital image display/processing techniques. In particular, a flat panel display that provides, in principle, a fixed number of pixels, and that is adapted to a liquid crystal display television or a plasma display panel (PDP) television is fundamentally suitable for digital signal processing. Therefore, various dedicated digital image signal processing techniques have been put on the market. In general, commercial television display presents 256 shades for each color. Nevertheless, methods of displaying 1024 shades for each color have also been proposed and some of the methods have already been put to practical use. High-quality image display represented by high-definition television broadcast is requested to provide higher image quality. Provision of a larger number of gray-scale levels or shades is a critical factor for realizing higher image quality.

(Overview of a Background Art Concerning a Liquid-Crystal Display Device)

A typical gray-scale display method adopted for conventional liquid-crystal displays (LCDs) utilizes, as indicated by the graph of FIG. 1, the characteristic of a liquid-crystal display based on a light intensity dependent on an effective applied voltage value (root-mean-square (rms) voltage).

Theoretically, if the effective values of an applied voltage indicated in FIG. 1 are finely and strictly determined (for example, in units of 2 mV), 2000 shades can be realized until the applied voltage reaches a saturation value of 4 V. For each color, ten bits to eleven bits, that is, one billion shades to eight billion shades can be reproduced. However, in reality, because of restrictions imposed in terms of the precision in controlling a voltage applied to a thin-film transistor (TFT) that drives a liquid crystal in charge of each pixel (precision in determining a voltage value or a variance among thresholds determined for transistors) and the characteristic of liquid crystals concerning a dielectric constant, a voltage is controlled in units of eight bits for each color, that is, in units of a voltage value ranging from 15 mV to 20 mV for each color. According to a conventional method of controlling an effective driving voltage, it is impossible to realize display of a sufficiently large number of shades, which is represented by ten bits or twelve bits, for each color.

(Details of the Background Art)

By merely controlling an effective applied voltage value, shades cannot be precisely controlled in practice as described previously.

Other conventionally known gray-scale display methods include (1) a pulse width modulation method of modulating the duration of an applied voltage pulse, (2) a multiple light intensity control by area, and (3) a dither method based on an error diffusion method.

Among the above methods, the pulse width modulation method is a method of effectively modulating a light intensity by varying the number of times by which a display element is turned on or off during each of sub frames. This method is applicable to a device that responds very quickly to an applied voltage. However, the pulse width modulation method cannot be applied to conventional LCDs because the liquid crystals employed in the conventional LCDs suffer a low electro-optical response speed.

Moreover, the multiple light intensity control by area is effectively adopted for printed matters. However, when the multiple light intensity control by area is adopted for LCDs that provides a fixed number of pixels in principle, degradation of a resolution of images is unavoidable. Therefore, the multiple light intensity control by area contradicts a method of increasing the number of shades while pursuing high quality and invites degradation of image quality.

Furthermore, the dither method is a method of modulating a video signal itself according to the contents of each display frame image. The dither method can increase the number of shades without great degradation of a resolution. However, when the dither method is adapted to display of mainly a motion picture, signal processing must be performed very fast. In practice, there is difficulty in applying the dither method to display of a motion picture.

Consequently, the pulse width modulation method or any other similar method must be adopted, and a response speed at which liquid crystals respond to application of a signal must be drastically improved in order to display a large number of shades, which are represented by ten or more bits, for each color on an LCD. The other possibilities are very low.

(Technological Situation of the Field Concerned)

In general, gray-scale display methods that can be adapted to full-color rendering display for LCDs or so-called full-color display include an analog gray-scale method and a digital gray-scale method. Coloring techniques include a color filtering technique (or a spatial color display technique) and a time-division coloring technique (or a temporal color display technique). These methods and techniques will be described below.

(Gray-Scale Display Method)

The electro-optic response made by a twisted nematic liquid-crystal display (LCD) that adopts a twisted nematic mode which is the principles of display widely adopted for LCDs will be discussed below based on the relationship between a light intensity and an effective value of an applied voltage. As shown in the graph of FIG. 2, the light intensity continuously changes along with a change in the effective value of an applied voltage.

The change in the light intensity is determined with the change in the effective value of the applied voltage. If a certain voltage value is designated, the light intensity is uniquely determined. In other words, display not causing a hysteresis can be achieved. In the twisted nematic LCD, display of any half-tone, that is, analog gray-scale display can be achieved by changing the effective value of the voltage applied to the LCD panel.

On the other hand, as far as a ferroelectric liquid-crystal display (LCD) that quickly responds to an applied voltage is concerned, a light intensity depends, as shown in the graph of FIG. 3, on the polarity of the applied voltage. In this case, the light intensity does not change irrespective of the strength of an applied voltage. A contrast depends exclusively on the polarity of an applied voltage. Consequently, in the ferroelectric LCD, unlike the twisted nematic LCD, gray-scale display is not controlled based on the effective value of an applied voltage but a so-called pulse width modulation method that makes the most of the quick response characteristic of the ferroelectric LCD is adopted.

(Color Display Technique)

As for a technique for color display, a conventionally widely adopted method employs a micro color filter. According to this method, as seen from the illustrative diagram of FIG. 4, one pixel location in an LCD is divided into at least three sub-pixel locations, and each of the sub-pixel locations is provided with red, blue, and green color filters. A liquid crystal located at each sub-pixel location optically turns on or off a continuously glowing backlight that emits white light, whereby space-division color display is achieved. At this time, as mentioned above, an amount of transmitted light is continuously controlled by adjusting a voltage or a pulse width. Consequently, in principle, any color can be displayed.

In contrast, a technique for temporally dividing colors is a time-division color display method. According to the method, as seen from the graph and illustrative diagram included in FIG. 5, one pixel location takes charge of one pixel, and pixel locations are quickly and optically switched in order to achieve color display. In general, a quick-response liquid-crystal display device is used in combination with red, blue, and green LEDs. The quick-response liquid-crystal display device controls the LEDs, which are light sources, synchronously with the light emission of each of the LEDs.

So-called full-color display achieved in the foregoing LCDs is requested to render colors highly faithfully along with recent rapid prevalence of flat-panel displays. In particular, for display of pictures represented by a television picture, high image quality and high color-rendering faithfulness that are as high as those of gravure printing are requested. Namely, full-color display achieved by conventional LCDs is 256-level gray-scale display or display of 256 shades, while full-color display achieved through gravure printing is display of 512, 1024, or 2048 shades.

(Problems to be Solved by the Related Art)

The problems underlying the foregoing color display methods that attempt to cope with the request for high image quality and high color-rendering faithfulness will be described below.

(Analog Gray-Scale Method)

One of advantages of LCDs including a twisted nematic LCD over other types of flat-panel displays is that a low voltage is used for driving. Especially for a television that is requested to achieve high-definition display or a display for mobile equipment that is, in principle, driven using a battery, the low-voltage driving is advantageous in terms of reduction in the cost of a driver or low power consumption.

When analog gray-scale display is achieved by controlling the effective value of an applied voltage, since a driving voltage is low, the applied voltage must be controlled highly precisely irrespective of what shade is displayed. For example, assuming that the saturation value of a voltage is 2.5 V, the voltage to be applied must be controlled in units of 2.5 V/256=9.76 mV in order to display each of 256 shades. Consequently, when a 1024-level gray scale is adopted, display of each shade must be controlled in units of 2.44 mV. Although a drifting in a voltage applied by a driver LSI is greatly alleviated, it is normally very hard to control an applied voltage in units of several millivolts.

Furthermore, the unit of controlling an applied voltage is calculated on the assumption that a liquid-crystal display panel is homogenous over the entire display surface. A certain difference among LCD panels that are mass-produced in reality must be permitted due to a restriction derived from a yield of manufacture. Consequently, in practice, controllable analog display is said to be limited to display of 256 shades at most.

(Digital Gray-Scale Method)

Gray-scale display methods including a pulse width modulation technique can be in principle adapted to a quick-response liquid-crystal display technology implemented in a ferroelectric liquid-crystal display or the like. Gray-scale display based on the pulse width modulation technique will be described by taking a typical frame frequency of 60 Hz for instance.

Eight display periods are determined within a period equivalent to 60 Hz, that is, 16.7 ms. At this time, a luminance of glow (or a luminance attained during the display period) remains constant. Since the light emission times are different from one another, a cumulative luminance attained during one frame varies. The graph of FIG. 6 indicates a concrete example of the light emission times equivalent to sub frames. As seen from FIG. 6, assuming that the display period of 16.7 ms is divided into eight time blocks that are the sub frames, when the time blocks to be combined as one frame are varied, even if the luminance of glow is constant, the cumulative luminance varies. Thus, gray-scale display is achieved.

In order to achieve gray-scale display by combining sub frames, the luminance levels of glows occurring during the respective sub frames must be clearly discriminated from one another. It is therefore a must that the turn-on time and turn-off time required by liquid crystals must be short enough. For example, assume that the display period of 16.7 ms is divided into eight time blocks 1, 2, 4, 8, 16, 32, 64, and 128 and that some of the time blocks are combined in order to produce 256 shades (represented by eight bits). In this case, the sum of the turn-on and turn-off times to be spent during the time block 1 must be equal to or shorter than 130 μs(=16.7 ms/128).

As far as a ferroelectric liquid-crystal display is concerned, the above response time is reportedly ensured in some cases under an environment in which the temperature is equal to or higher than a room temperature. However, in an environment in which the temperature is equal to or lower than the room temperature, the response time largely exceeds 130 μs. Consequently, it is very hard to drive ferroelectric liquid crystals at a temperature falling within a practical range of values.

In contrast, on condition that the digital gray-scale display method is adopted and that an active matrix display technique is implemented as it is in a TFT-LCD, a technique of continuously controlling the turn-on time during one frame of 16.7 ms has been proposed and put to practical use. Specifically, the quantity of light transmitted by each pixel location in a liquid-crystal display is held constant all the time, and the light emission times within one frame are continuously controlled in order to digitally reproduce shades.

When the technique schematically shown in the graph of FIG. 7 is adopted, as long as the response time of liquid crystals is much shorter than 16.7 ms and the response time of an active thin-film transistor can be controlled during a short enough time, 1024 shades can be reproduced. However, as far as almost all conventionally known LCDs employing nematic liquid crystals are concerned, the response time of typical liquid crystals is about 10 ms. In order to control the turn-on time of liquid crystals at 1024 steps during the remaining 6.7 ms, each shade must be controlled during about 6.5 μs.

In general, the response time of liquid crystals gets longer along with a drop in an ambient temperature. When the temperature is about 10° C., the turn-on time of a thin-film transistor associated with each shade is several tens of nanoseconds. An LCD adopting a single-crystal silicon or an LCD employing high-temperature polysilicon TFTs can attain the turn-on time of several tens of nanoseconds. However, it is hard for an LCD employing low-temperature polysilicon TFTs or amorphous silicon TFTs to attain the turn-on time.

In particular, there is presumably difficulty in employing TFTs other than amorphous silicon TFTs in a large-scale direct-vision TFT-LCD in terms of a cost of manufacture. In reality, it is hard to adapt the digital gray-scale display method, which continuously controls the turn-on time within one frame, to the large-scale direct-vision LCD that is requested especially to achieve display of a high-quality motion picture.

### SUMMARY OF THE INVENTION

An object of the present invention is to provide a method of driving a liquid-crystal display device capable of solving the problems encountered in the above-mentioned prior art.

Another object of the present invention is to provide a method of driving a liquid-crystal display device capable of making an electro-optic response during a short period of time (for example, about 150 microseconds) and capable of continuously displaying shades according to an applied voltage.

According to the present invention, there is provided a method of driving a liquid-crystal display device that comprises at least a pair of substrates and a liquid-crystal material disposed between the pair of substrates.

The driving method is such that a voltage increase rate to be attained during the duration of a voltage pulse applied to the liquid-crystal display device is changed in order to continuously control the quantity of light transmitted by the liquid-crystal display device so that shades can be to displayed.

In the driving method according to the present invention, when for example, a polarization shielded smectic liquid crystal display capable of quickly responding to an applied voltage is adopted, if a pulse width modulation technique and a technique of changing a light intensity according to the electro-optic response characteristic of the polarization shielded smectic liquid crystal display are adopted in addition to a conventional method of changing a light intensity according to an effective value of an applied voltage, a large number of shades represented by ten bits or more can be displayed for each color.

The present invention can preferably be implemented in, for example, a polarization shielded smectic liquid-crystal display device (PSS-LCD) proposed by the present inventor et al. (for details of the PSS-LCD, refer to U.S. Patent No. 2004-196428).

According to one aspect of the present invention implemented in a PSS-LCD, an electro-optic response can be made during 150 microseconds and shades can be continuously displayed according to an applied voltage.

As mentioned above, even if a response time of 150 μs is attained, shades represented by ten bits or more cannot be reproduced for each color merely by performing pulse width modulation. Even when shades represented by eight bits are displayed for each color, a quick response to be made during a response time of 130 μs or less is requested within a wide range of temperatures. Consequently, when a quick response can be made stably during about 150 μs, if a large number of shades represented by ten bits or more is requested to be displayed for each color, some conventionally adopted techniques cannot be cope with the request.

In contrast, according to the present invention, as mentioned above, an electro-optic response can be made during 150 microseconds and shades can be continuously displayed according to an applied voltage.

Further scope of applicability of the present invention will become apparent from the detailed description given hereinafter. However, it should be understood that the detailed description and specific examples, while showing preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a graph schematically showing a general gray-scale display method adapted to a conventional liquid-crystal display (LCD).

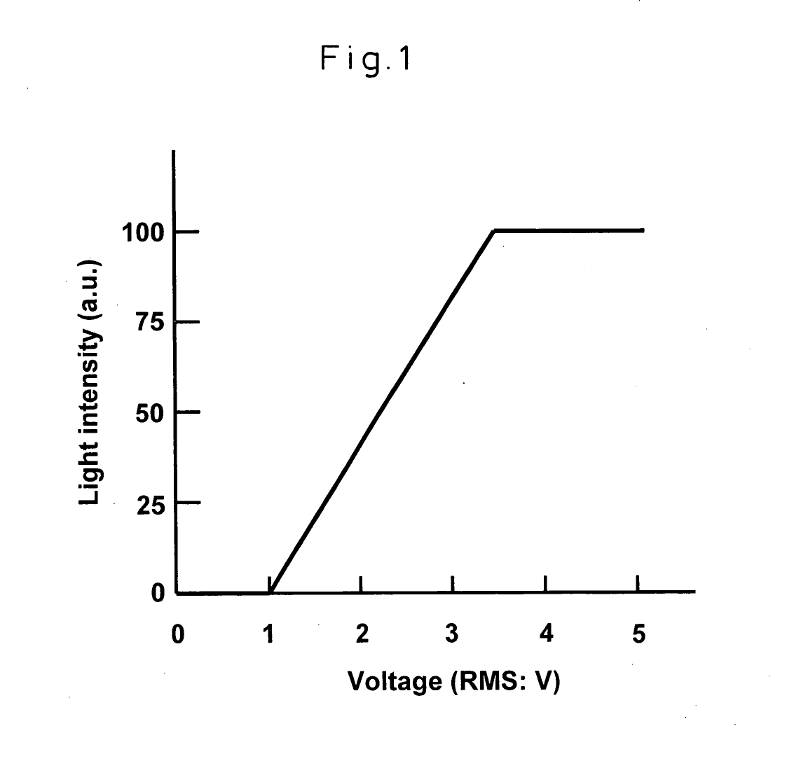

FIG. 2 is a graph schematically showing an electro-optic response made by a conventional twisted nematic LCD.

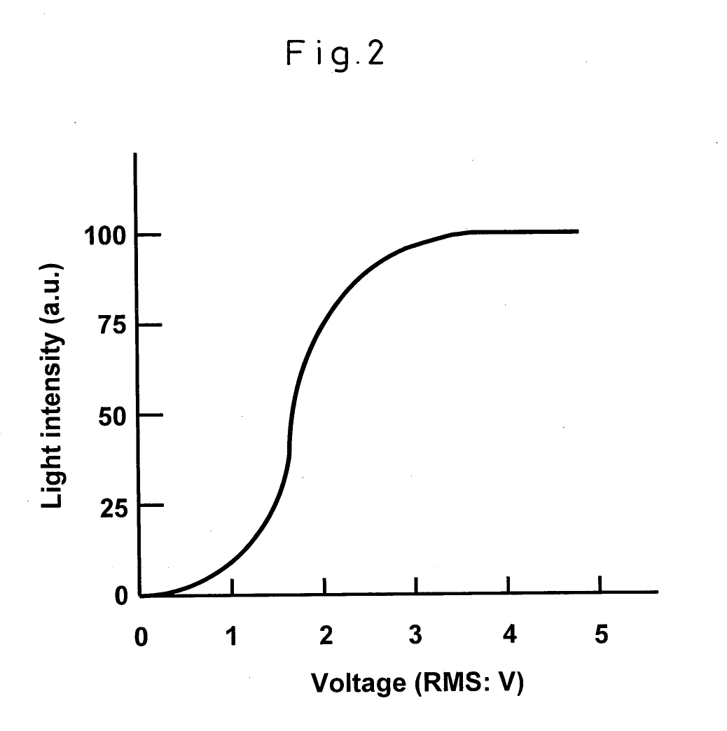

FIG. 3 is a graph schematically showing an example of the relationship between the polarity of an applied voltage and a light intensity observed in a conventional ferroelectric liquid-crystal display (FLCD).

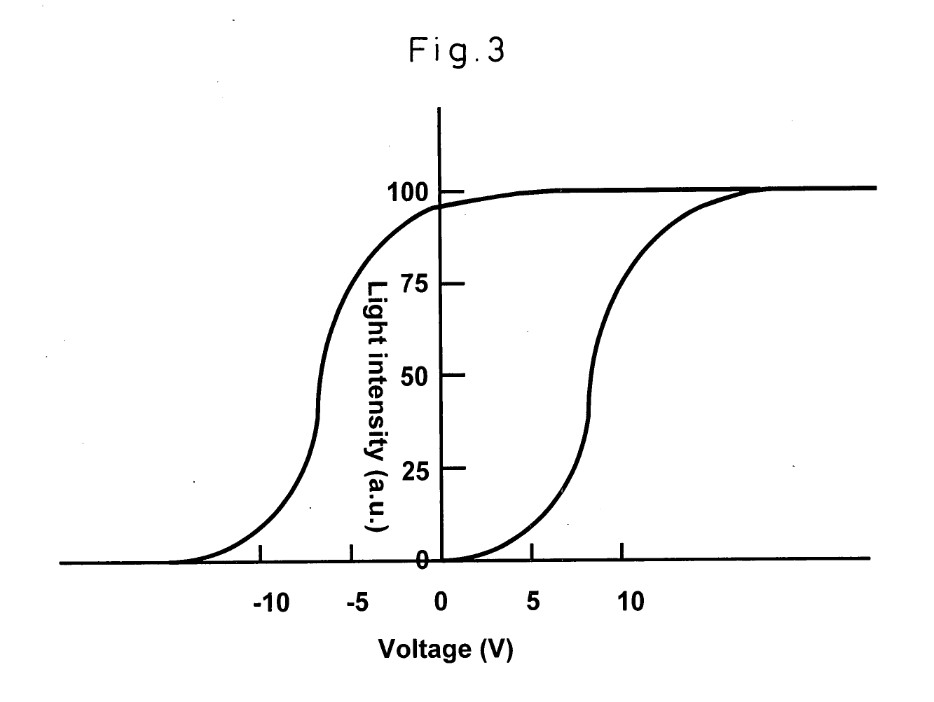

FIG. 4 is an illustrative diagram explanatory of color display to be achieved using conventional micro color filters.

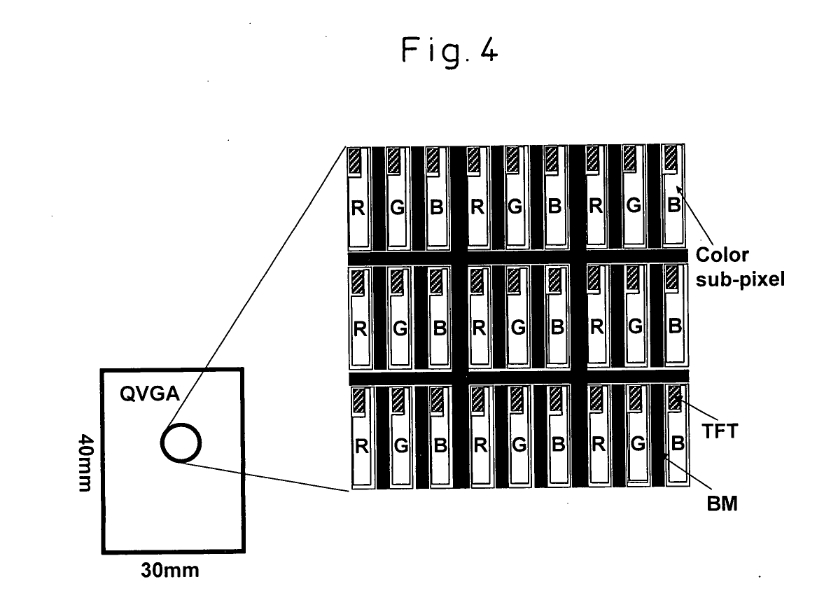

FIG. 5 includes a graph and an illustrative diagram explanatory of a conventional time-division color display method.

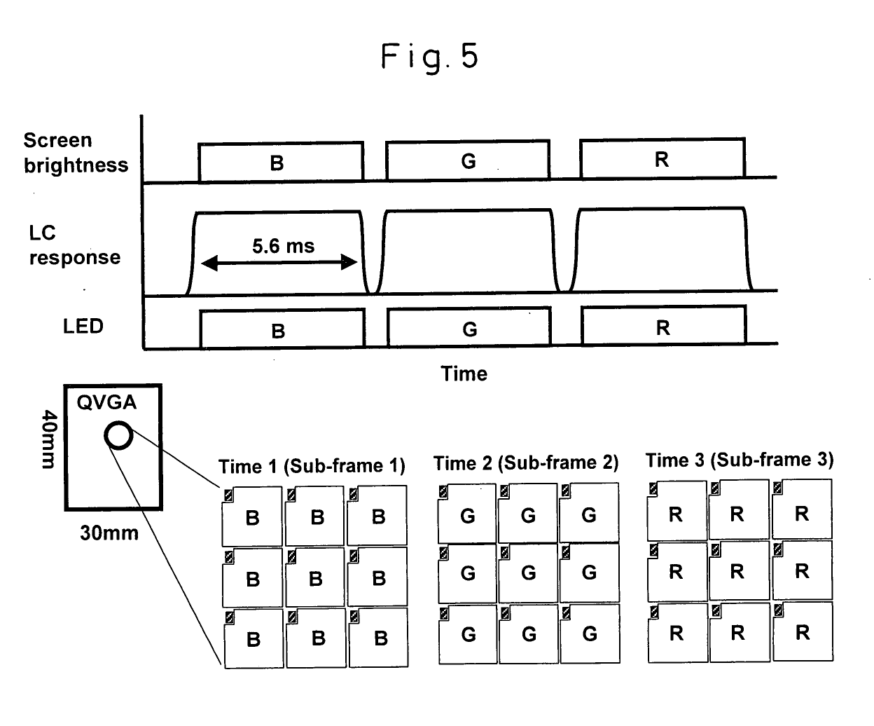

FIG. 6 is a graph explanatory of a gray-scale display method based on a conventional pulse width modulation technique.

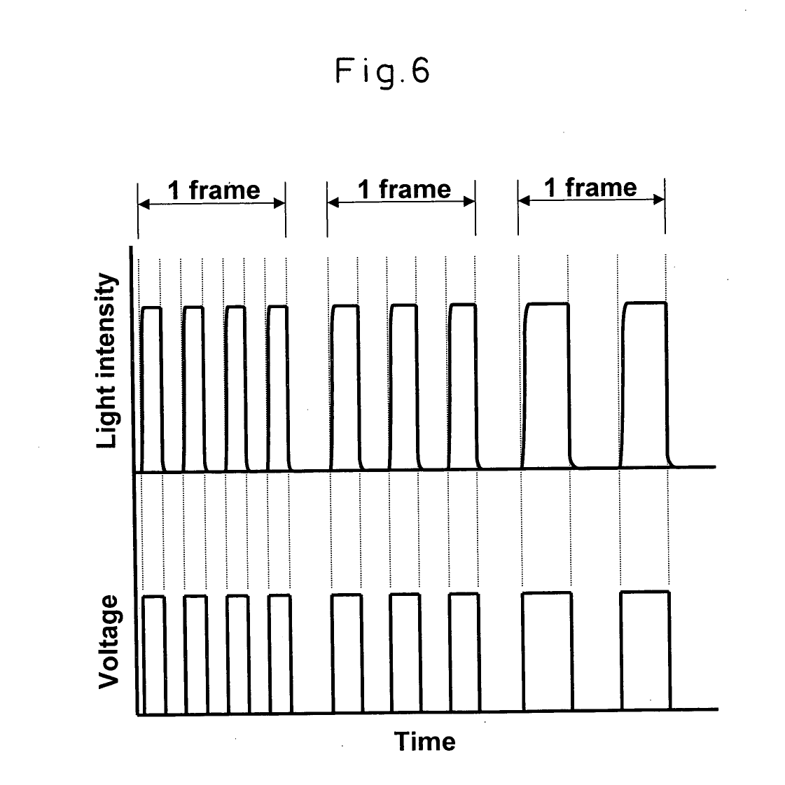

FIG. 7 is a graph explanatory of a conventional digital gray-scale method of continuously controlling the light emission times within one frame.

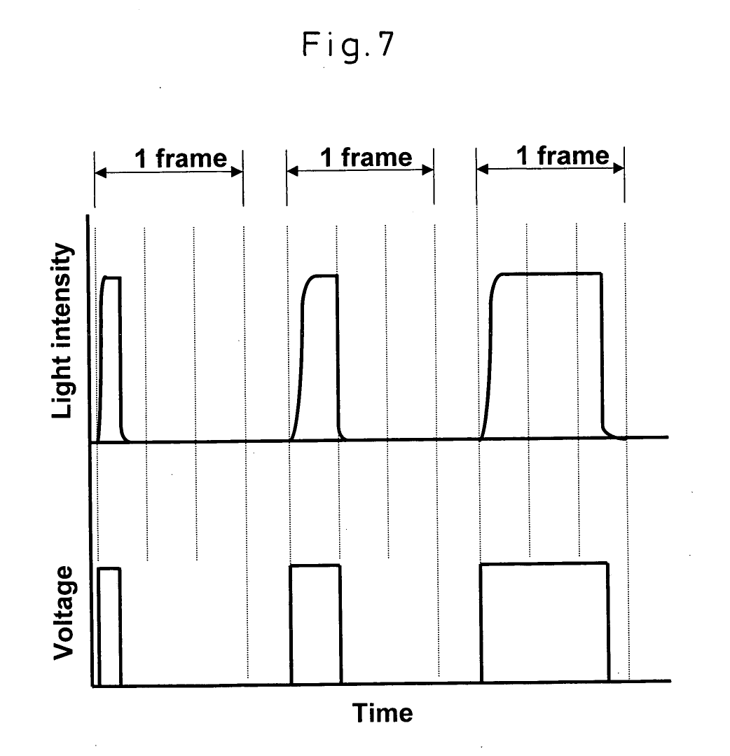

FIG. 8 schematically shows the relationship between a quadra-pole momentum and a response speed.

FIG. 9 is an illustrative graph showing the concept of precise gray-scale control based on a method of controlling a cumulative quantity of light transmitted during turn-on times within one frame which may be adapted to the present invention.

FIG. 10 is an illustrative graph showing the concept of a method of bringing an applied voltage to an on state at least two time instants which may be adapted to the present invention.

FIG. 11 an illustrative diagram explanatory of the concept of an optical response time required by a PSS-LCD adopting a dV/dt control method which may be adapted to the present invention.

FIG. 12 is a graph showing an example of a phenomenon, in which a response characteristic continuously changes along with a change in a dV/dt value, observed in an embodiment of the present invention.

FIG. 13 is a graph showing another example of the phenomenon, in which a response characteristic continuously changes along with a change in a dV/dt value, observed in an embodiment of the present invention.

FIG. 14 is a graph showing another example of the phenomenon, in which a response characteristic continuously changes along with a change in a dV/dt value, observed in an embodiment of the present invention.

FIG. 15 is a graph showing another example of the phenomenon, in which a response characteristic continuously changes along with a change in a dV/dt value, observed in an embodiment of the present invention.

FIG. 16 is a graph summarizing the graphs of FIG. 12 to FIG. 15.

FIG. 17 is a graph showing the results of measurement of a time dependency (response characteristic) of the quantity of light transmitted by a PSS-LCD panel in which an embodiment of the present invention is implemented.

FIG. 18 is a graph showing the results of measurement of a time dependency (response characteristic) of the quantity of light transmitted by a PSS-LCD panel in which an embodiment of the present invention is implemented.

FIG. 19 schematically shows an example of initial molecular configuration and configuration under applied voltage of PSS-LCD.

FIG. 20 schematically shows an example of coordination of PSS-LC molecular setting.

FIG. 21 schematically shows an example of molecular tilt angle of smectic liquid crystal to smectic layer.

FIG. 22 schematically shows an example of dielectric behavior of SSFLCD and PSS-LCD.

FIG. 23 schematically shows examples of optical response of PSS-LCD.

FIG. 24 schematically shows an example of the design for the direction of the pre-set liquid crystal molecular alignment to be used in the present invention.

FIG. 25 schematically shows an example of the “dark” state at an isotropic phase.

FIG. 26 schematically shows another example of the “dark” state wherein the pre-set liquid crystal molecular alignment direction is parallel to the polarizer direction.

FIG. 27 schematically shows an example of the “light leakage” state wherein the liquid crystal panel is rotated, and the incident linearly polarized light changes its polarization.

FIG. 28 schematically shows an example of the liquid crystal molecular configuration of Smectic A phase having a layer structure

FIG. 29 schematically shows an example of the “light leakage” state of the smectic A phase, when the panel is rotated.

FIG. 30 schematically shows an example of the conventional smectic liquid crystals showing smectic C phase or chiral smectic C phase, depending on its achirality or chirality.

FIG. 31 schematically shows an example of the light transmittance situation of the PSS phase, which is the same as that of smectic A phase in general.

FIG. 32 schematically shows an example of the state wherein the tilt angle gradually increases with decrease of ambient temperature.

FIG. 33 schematically shows an example of the difference in n-director direction between conventional smectic C phase and the PSS-LC phase, in terms of temperature dependence of the light intensity by rotation of the liquid crystal panel under the crossed Nicole.

FIG. 34 schematically shows another example of the difference in n-director direction between conventional smectic C phase and the PSS-LC phase, in terms of temperature dependence of the light intensity by rotation of the liquid crystal panel under the crossed Nicole.

FIG. 35 schematically shows an example of the V-T (voltage to transmittance) curve of the PSS-LCD wherein the dependence of applied electric field strength of the PSS-LCD presents an analog response.

FIG. 36 schematically shows an example of the V-T curve of the conventional smectic C, or chiral smectic C phase wherein the V-T curve shows hysteresis.

### DETAILED DESCRIPTION OF PREFERRED EMBODIMENTS

Hereinbelow, the present invention will be described in detail with reference to the accompanying drawings, as desired. In the following description, “%” and “part(s)” representing a quantitative proportion or ratio are those based on mass, unless otherwise noted specifically.

(Method of Driving a Liquid-Crystal Display Device)

The present invention provides a method of driving a liquid-crystal display device that comprises at least a pair of substrates and a liquid crystal material disposed between the pair of substrates. According to the present invention, a voltage increase rate to be attained during the duration of a voltage pulse applied to the liquid-crystal display device is changed in order to continuously control the quantity of light transmitted by the liquid-crystal display device so that shades can be displayed.

(Preferred Method of Applying a Pulse)

According to the present invention, preferably, for example, a voltage pulse described below may be applied to a liquid-crystal display device.

(1) Preferred waveform: a trapezoidal waveform. The waveform signifies that a voltage rises at a derivative to a time that is varied.

(2) Preferred range of pulse widths or pulse durations: depends on a frame frequency. Assuming that a frame frequency is 60 Hz, the maximum value of a pulse width is 16.7 ms and the minimum value thereof is equivalent to the shortest response time within which liquid crystals can respond to an applied voltage (for example, 100 μs).

(3) The maximum value of the pulse duration is 16.7 ms, and the minimum value thereof is equivalent to the shortest response time within which liquid crystals can respond to an applied voltage (for example, 100 μs).

(Modes of the Present Invention)

The present invention is available in various modes described below.

(First Mode)

In the first mode, a maximum quantity of light transmitted by a liquid-crystal display device within one frame remains constant, and a voltage increase rate to be attained during the duration of a voltage pulse applied to the liquid-crystal display device is changed in order to continuously control a cumulative quantity of light transmitted by the liquid-crystal display device. Thus, shades are displayed.

(Preferred Method of Applying a Pulse)

In the first mode, preferably, a voltage pulse described below may be applied to the liquid-crystal display device.

(1) Preferred waveform: a trapezoidal waveform. The waveform signifies that a voltage rises at a derivative of to a time that is varied.

(2) Preferred range of pulse widths or pulse durations: depends on a frame frequency. Assuming that the frame frequency is 60 Hz, the maximum value of a pulse width is 16.7 ms, and the minimum value thereof is equivalent to the shortest response time within which liquid crystals can respond to an applied voltage (for example, 100 μs).

(3) The maximum value of the pulse duration is 16.7 ms, and the minimum value thereof is equivalent to the shortest response time within which liquid crystals can respond to an applied voltage (for example, 100 μs).

(Second Mode)

In the second mode, the crest value of a voltage to be attained during the duration of a voltage pulse applied to the liquid-crystal display device is changed in order to continuously control the quantity of light transmitted by the liquid-crystal display device. Thus, shades are displayed.

(Preferred Method of Applying a Pulse)

In the second mode, preferably, a voltage pulse described below may be applied to the liquid-crystal display device.

(1) Preferred pulse shape: analogous to the waveform of a voltage employed in a conventional twisted nematic (TN) liquid crystal display (LCD). The waveform of an applied voltage expresses a change in the crest value of the voltage. The crest value of the voltage is changed in order to change the quantity of light transmitted by a liquid-crystal display panel.

(2) Preferred range of pulse widths or pulse durations:

In the present mode, the quantity of light transmitted by a liquid-crystal display panel is determined with an effective value of an applied voltage. Normally, the simplest rectangular wave can be employed. Unlike conventional LCDs including the twisted nematic LCD, in a PSS-LCD, an optical response of liquid crystals is very slow. Therefore, the pulse duration may be equal to or longer than the shortest time within which the PSS-LCD normally responds to an applied voltage, that is, 100 μs, and may fall within a time determined with a frame frequency (for example, when the frame frequency is 60 Hz, 16.7 ms or less).

(3) Pulse duration:

In the second mode, the pulse duration falls within the same range as the preferred range of pulse widths or pulse durations described in (2).

(Third Mode)

In the third mode, the crest value of a voltage to be attained during the duration of a voltage pulse applied to the liquid-crystal display device is changed in order to continuously control the quantity of light transmitted by the liquid-crystal display device. Thus, shades are displayed.

(Preferred Method of Applying a Pulse)

In the third mode, preferably, a voltage pulse described below may be applied to the liquid-crystal display device.

(1) Preferred pulse shape: a trapezoidal waveform having at least two steps. The waveform signifies that a voltage rises stepwise at a derivative to a time that is varied between two values.

(2) Preferred range of pulse widths or pulse durations: depends on a frame frequency. Assuming that the frame frequency is 60 Hz, the maximum value of the pulse width of a voltage that rises to follow the first and second steps is 16.7 ms, the minimum value thereof is equivalent to the shortest response time within which liquid crystals can respond to an applied voltage (for example, 100 μs). If the frame frequency is high, the maximum value of a pulse width is equivalent to a full inter-frame time determined with the frame frequency, and the minimum value thereof is equivalent to the shortest response time within which liquid crystals can respond to an applied voltage (for example, 100 μs).

(3) Preferred range of voltage increase rates to be attained during a pulse duration: depends on the number of steps a pulse exhibits and a frame frequency. For example, assuming that a pulse exhibits three steps and the frame frequency is 60 Hz, the maximum value of a rate at which a voltage increases time-sequentially (dV/dt) is theoretically infinite (when a voltage rises stepwise). The minimum voltage increase rate is a voltage increase rate (dV/dt=Vmax/5.8 ms) calculated by dividing the maximum applied voltage value by 5.8 ms that is a quotient of 17.6 ms by 3.

(Fourth Mode)

In the fourth mode, both a voltage increase rate to be attained during the duration of a voltage pulse applied to the liquid-crystal display device, and the crest value of a voltage are changed in order to continuously control the quantity of light transmitted by the liquid-crystal display device. Thus, shades are displayed.

(Preferred Method of Applying a Pulse)

In the fourth mode, preferably, a voltage pulse described below may be applied to the liquid-crystal display device.

(1) In the fourth mode, a wave having the combination of the waveforms employed in the first and second embodiments may be adopted.

(Liquid-Crystal Display Device)

A liquid-crystal display device to which the driving method in accordance with the present invention can be adapted is not limited to any specific one. From the viewpoint of high color-rendering faithfulness, the liquid-crystal display device may preferably be a PSS-LCD (polarization shielded smectic liquid-crystal display device).

(Details of the PSS-LCD)

(Liquid Crystal Device)

The liquid crystal device according to the present invention comprises, at least a pair of substrates; and a Smectic phase liquid crystal material disposed between the pair of substrates.

### First Embodiment

In a first preferred embodiment of the present invention, the liquid crystal device may preferably comprise, at least a pair of substrates; and a Smectic phase liquid crystal material disposed between the pair of substrates, wherein the molecular long axis or n-director of the Smectic phase liquid crystal material has a tilt angle to its layer normal as a bulk material, and the molecular long axis of the Smectic phase liquid crystal material aligns parallel to the pre-setting alignment direction, resulting in its long axis layer normal.

(Molecular Tilt from Layer Normal)

Using a polarized microscope whose analyzer and polarizer are set as cross Nicole, the liquid crystal molecular direction (n-director) is measurable. If the n-director is aligned as the layer normal, under the cross Nicole setting, the light transmittance through from the liquid crystal panel is the minimum or showing the extinction angle, when the pre-setting molecular alignment direction fits with the absorption angle of the analyzer. If the n-director is not aligned as layer normal, which has a tilt angle from the layer normal, under the cross Nicole setting, the light transmittance through the liquid crystal panel is not the minimum or not showing the extinction angle.

### Second Embodiment

In a second preferred embodiment of the present invention, the liquid crystal device may preferably comprise, at least a pair of substrates; and a Smectic phase liquid crystal material disposed between the pair of substrates, wherein the molecular long axis or n-director of the Smectic phase liquid crystal material has a tilt angle to its layer normal as a bulk material, and the liquid crystal device shows extinction angle along with the initial pre-setting alignment direction.

(Confirmation of Extinction Angle)

The above-mentioned extinction angle of the liquid crystal device may be confirmed by the following method.

Under a polarized microscope whose analyzer and polarizer are set as cross Nicole, the direction of the liquid crystal molecule's n-director is easily detected as following. At the theta-stage of the polarized microscope, the liquid crystal panel is rotated. The light through the panel is function of the rotational angle. If the light throughput shows the minimum, the angle given the minimum light is the extinction angle. If the light shows not the minimum, the angle given the non-minimum light throughput is not the extinction angle.

### Third Embodiment

In a third preferred embodiment of the present invention, the liquid crystal device may preferably comprise, at least a pair of substrates; and a Smectic phase liquid crystal material disposed between the pair of substrates, the Smectic phase liquid crystal material aligning its molecular long axis having a tilt angle to its layer normal as a bulk material, wherein the surface of the substrates has a strong enough azimuthal anchoring energy to cause the molecular long axis of the Smectic phase liquid crystal material to align to parallel to the pre-setting alignment direction making its molecular long axis normal to its layer.

(Confirmation of Strong Enough Azimuthal Anchoring Energy)

In the present invention, the above-mentioned strong enough azimuthal anchoring energy may be confirmed by confirming that the molecular long axis of the Smectic phase liquid crystal material aligns to parallel to the pre-setting alignment direction making its molecular long axis normal to its layer. This confirmation may be effected by the following method.

In general, azimuthal anchoring energy is measurable by so called the crystal rotation method. This method is described in such as “An improved Azimuthal Anchoring Energy Measurement Method Using Liquid Crystals with Different Chiralities”: Y. Saitoh and A. Lien, Journal of Japanese Applied Physics Vol. 39, pp. 1793 (2000). The measurement system is commercially available from several equipment companies. In here, particularly the strong enough azimuthal anchoring energy is very clear to be confirmed as following. The meaning of “strong enough azimuthal anchoring energy” is the most necessary to obtain the liquid crystal molecule's n-director aligned to along with pre-set alignment direction using the liquid crystal molecule whose n-director usually aligns with a certain angle of tilt from layer normal. Therefore, if the prepared surface successfully aligns the liquid crystal's n-director along with the pre-set alignment direction, it means “strong enough” anchoring energy.

(Liquid Crystal Material)

In the present invention, a Smectic phase liquid crystal material is used. Herein, “Smectic phase liquid crystal material” refers to a liquid crystal material capable of showing a Smectic phase. Accordingly, it is possible to use a liquid crystal material without particular limitation, as long as it can show a Smectic phase.

(Preferred Liquid Crystal Material)

In the present invention, it is preferred to use a liquid crystal material having the following capacitance property.

(Capacitance Property)

Although the PSS-LCD uses smectic liquid crystal materials, due to its expected origin of the induced polarization created from quadra-pole momentum, pixel capacitance at each LCD is small enough compared to conventional LCDs. This small capacitance at each pixel will not request any particular change of TFT design. The major design issue at TFT is its required electron mobility and its capacitance with keeping high aperture ratio. Therefore, if the new LCD drive mode requires more capacitance, TFT is necessary to have a major design change, which is not easy both in terms of technically and economically. One of the most important benefits of the PSS-LCD is its smaller capacitance as a bulk liquid crystal capacitance. Therefore, if the PSS-LC materials are used as a transmittance type of LCD, its pixel capacitance is almost half to one third compared to that of conventional nematic base LCD. If the PSS-LCD is used as reflective LCD such as LCoS display, its pixel capacitance is almost same with that for transmittance nematic base LCD, and almost half to one third compared that of reflective conventional nematic base LCD.

<Method of Measuring the Capacitance Property>

The pixel capacitance of the LCD is commonly measured by the standard method described in following.

Liquid crystal device handbook: Nikkan Kogyo in Japanese Chapter 2, Section 2.2: pp. 70, Measuring method of liquid crystal properties

A liquid crystal panel to be examined is inserted between a polarizer and an analyzer which are arranged in a cross-Nicole relationship, and the angle providing the minimum light quantity of the transmitted light is determined while the liquid crystal panel is being rotated. The thus determined angle is the angle of the extinction position.

(Liquid Crystal Material having Preferred Property)

In the present invention, it is required to use a liquid crystal material belonging to the least symmetrical group. The requirement for the PSS-LCD performance from the view point of the liquid crystal materials is enhancement of quadra-pole momentum in the liquid crystal device. Therefore, the used liquid crystal molecule must have the least symmetrical molecular structure. The exact molecular structure is dependent on the required performance as the final device. If the final device is for a mobile display application, rather low viscosity is more important than that for larger panel display application, resulting in smaller molecular weight molecules are preferred. However, the lower viscosity is the total property as the mixture. Some times, the mixture's viscosity is decided not by each molecular component, but by inter-molecular interaction. Even the optical performance requirement such as birefringence is also very dependent on application. Therefore, the most and solely requirement in the liquid crystal material here is its least symmetrical or the most asymmetrical molecular structure in the Smectic liquid crystal molecules.

(Specific Examples of Preferred Liquid Crystal Material)

In the present invention, it is preferred to use a liquid crystal material selected form the following liquid crystal materials. Of course, these crystal materials may be used as a combination or mixture of two or more kinds thereof, as desired. The Smectic liquid crystal material to be used in the present invention may be selected from the group consisting of: Smectic C phase materials, Smectic I phase materials, Smectic H phase materials, Chiral Smectic C phase materials, Chiral Smectic I phase material, Chiral Smectic H phase materials.

Specific examples of the Smectic liquid crystal material to be used in the present invention may include the following compounds or materials.

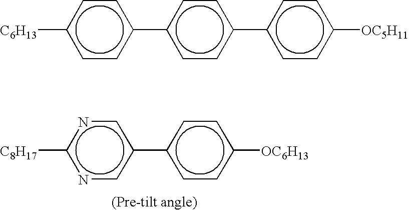

The surface of the substrates constituting the liquid crystal device according to the present invention may preferably have a pre-tilt angle to the filled liquid crystal material of no larger than 5 degrees, more preferably no larger than 3 degrees, further preferably no larger than 2 degrees. The pre-tilt angle to the filled liquid crystal material may be determined by the following method.

In general, the measurement method of pre-tilt at LCD device is used so called the crystal rotation method, which is popular and the measuring system is commercially available. However, here the required pre-tilt is not for Nematic liquid crystal materials, but for Smectic liquid crystal materials who has a layer structure. Therefore, the scientific definition of the pre-tilt angle is different from that for non-layer liquid crystal materials.

The requirement of the pre-tilt for the present invention is to stabilize azimuthal anchoring energy. The most important requirement for the pre-tilt is actually not for its angle, but stabilization of the azimuthal anchoring energy. As long as the pre-tilt angle does not have conflict with azimuthal anchoring energy, higher pre-tilt may be acceptable. So far, experimentally, current available alignment layers suggest lower pre-tilt angle to stabilize preferred molecular alignment. However, there is no particular scientific theory to deny higher pre-tilt angle requirement. The most important requirement to the pre-tilt is to provide stable enough PSS-LCD molecular alignment.

Most of commercially available polymer base alignment materials are sold with data of pre-tilt angle. If the pre-tilt angle is unknown, the value is measurable using the crystal rotation method as the representative pre-tilt for a specific cell condition.

(Provision of Anchoring Energy)

The method of providing the anchoring energy is not particularly limited, as long as the method may provide a strong enough azimuthal anchoring energy to cause the molecular long axis of the Smectic phase liquid crystal material to align to parallel to the pre-setting alignment direction making its molecular long axis normal to its layer. Specific examples of the method may include: e.g., mechanical buffing of a polymer layer; a polymer layer whose top surface has been exposed by polarized UV light; oblique evaporation of a metal oxide material, etc. Of these methods of providing the anchoring energy, a reference: Liquid crystal device handbook: Nikkan Kogyo in Japanese, Chapter 2, Section 2.1, 2.1.4: pp. 40, and 2.1.5 pp. 47, may referred to, as desired.

In the case of oblique evaporation of a metal oxide material, the oblique evaporation angle may preferably be no less than 70 degrees, more preferably no less than 75, further preferably no less than 80 degrees.

<Method of Measuring Molecular Initial Alignment State for Liquid Crystal Molecules>

In general, the major axis of liquid crystal molecules is in fair agreement with the optical axis. Therefore, when a liquid crystal panel is placed in a cross Nicole arrangement wherein a polarizer is disposed perpendicular to an analyzer, the intensity of the transmitted light becomes the smallest when the optical axis of the liquid crystal is in fair agreement with the absorption axis of the analyzer. The direction of the initial alignment axis can be determined by a method wherein the liquid crystal panel is rotated in the cross Nicole arrangement while measuring the intensity of the transmitted light, whereby the angle providing the smallest intensity of the transmitted light can be determined.

<Method of Measuring Parallelism of Direction of Liquid Crystal Molecule Major Axis with Direction of Alignment Treatment>

The direction of rubbing is determined by a set angle, and the slow optical axis of a polymer alignment film outermost layer which has been provided by the rubbing is determined by the kind of the polymer alignment film, the process for producing the film, the rubbing strength, etc. Therefore, when the extinction position is provided in parallel with the direction of the slow optical axis, it is confirmed that the molecule major axis, i.e., the optical axis of the molecules, is in parallel with the direction of the slow optical axis.

(Substrate)

The substrate usable in the present invention is not particularly limited, as long as it can provide the above-mentioned specific “molecular initial alignment state”. In other words, in the present invention, a suitable substrate can appropriately be selected in view of the usage or application of LCD, the material and size thereof, etc. Specific examples thereof usable in the present invention are as follows.

A glass substrate having thereon a patterned a transparent electrode (such as ITO)

An amorphous silicon TFT-array substrate

A low-temperature poly-silicon TFT array substrate.

A high-temperature poly-silicon TFT array substrate

A single-crystal silicon array substrate.

(Preferred Substrate Examples)

Among these, it is preferred to use following substrate, in a case where the present invention is applied to a large-scale liquid crystal display panel.

An amorphous silicon TFT array substrate

(Alignment Film)

The alignment film usable in the present invention is not particularly limited as long as it can provide the above-mentioned tilt angle, etc., according to the present invention. In other words, in the present invention, a suitable alignment film can appropriately be selected, in view of the physical property, electric or display performance, etc. For example, various alignment films as exemplified in publications may generally be used in the present invention. Specific preferred examples of such alignment films usable in the present invention are as follows.

Polymer alignment film: polyimides, polyamides, polyamide-imides

Inorganic alignment film: SiO2, SiO, Ta2O5, ZrO, Cr2O3, etc.

(Preferred Alignment Film Examples)

Among these, it is preferred to use the following alignment film, in a case where the present invention is applied to a projection-type liquid crystal display.

Inorganic Alignment Films

In the, present invention, as the above-mentioned substrates, liquid crystal materials, and alignment films, it is possible to use those materials, components or constituents corresponding to the respective items as described in “Liquid Crystal Device Handbook” (1989), published by The Nikkan Kogyo Shimbun, Ltd. (Tokyo, Japan), as desired.

(Other Constituents)

The other materials, constituents or components, such as transparent electrode, electrode pattern, micro-color filter, spacer, and polarizer, to be used for constituting the liquid crystal display according to the present invention, are not particularly limited, unless they are against the purpose of the present invention (i.e., as long as they can provide the above-mentioned specific molecular initial alignment state). In addition, the process for producing the liquid crystal display device which is usable in the present invention is not particularly limited, except the liquid crystal display device should be constituted so as to provide the above-mentioned specific molecular initial alignment state”. With respect to the details of various materials, constituents or components for constituting the liquid crystal display device, as desired, “Liquid Crystal Device Handbook” (1989), published by The Nikkan Kogyo Shimban, Ltd. (Tokyo, Japan) may be referred to.

(Means for Realizing Specific Initial Alignment)

The means or measure for realizing such an alignment state is not particularly limited, as long as it can realize the above-mentioned specific “molecular initial alignment state”. In other words, in the present invention, a suitable means or measure for realizing the specific initial alignment can appropriately be selected, in view of the physical property, electric or display performance, etc.

The following means may preferably be used, in a case where the present invention is applied to a large-sized TV panel, a small-size high-definition display panel, and a direct-view type display.

(Preferred Means for Providing Initial Alignment)

According to the present inventors' investigation and knowledge, the above-mentioned suitable initial alignment may easily be realized by using the following alignment film (in the case of baked film, the thickness thereof is shown by the thickness after the baking) and rubbing treatment. On the other hand, in ordinary ferroelectric liquid crystal displays, the thickness of the alignment film 3,000 A (angstrom) or less, and the strength of rubbing (i.e., contact length of rubbing) 0.3 mm or less.

Thickness of alignment film: preferably 4,000 A or more, more preferably 5,000 A or more (particularly, 6,000 A or more).

Strength of rubbing (i.e., contact length of rubbing): preferably 0.3 mm or more, more preferably 0.4 mm or more (particularly, 0.45 mm or more) The above-mentioned alignment film thickness and strength of rubbing may be measured, e.g., in a manner as described in Example 1 appearing hereinafter

(Comparison of the Present Invention and Background Art)

Herein, for the purpose of facilitating the understanding of the above-mentioned structure and constitution of the present invention, some features of the liquid crystal device according to the present invention will be described in comparison with those having different structures.

(Theoretical Background of the Invention)

The present invention is based on detail investigation and analysis of molecular alignment of the PSS-LCDs, which is thought to be significant advantages for small screen with high resolution LCDs and large screen direct view LCD TV applications as well as large magnified projection panels. Next, the technical background of the invention will be described.

(Polarization Shielded Smectic Liquid Crystal Displays)

The polarization shielded Smectic liquid crystal display (PSS-LCD) is described in the United States Patent application number US-2004/0196428 A1 that using the least symmetrical molecular structure's liquid crystal materials in order to enhance quadra-pole momentum. This patent application discusses the basic mechanism of the PSS-LCD. Also this patent describes a practical method to manufacture the PSS-LCDs.

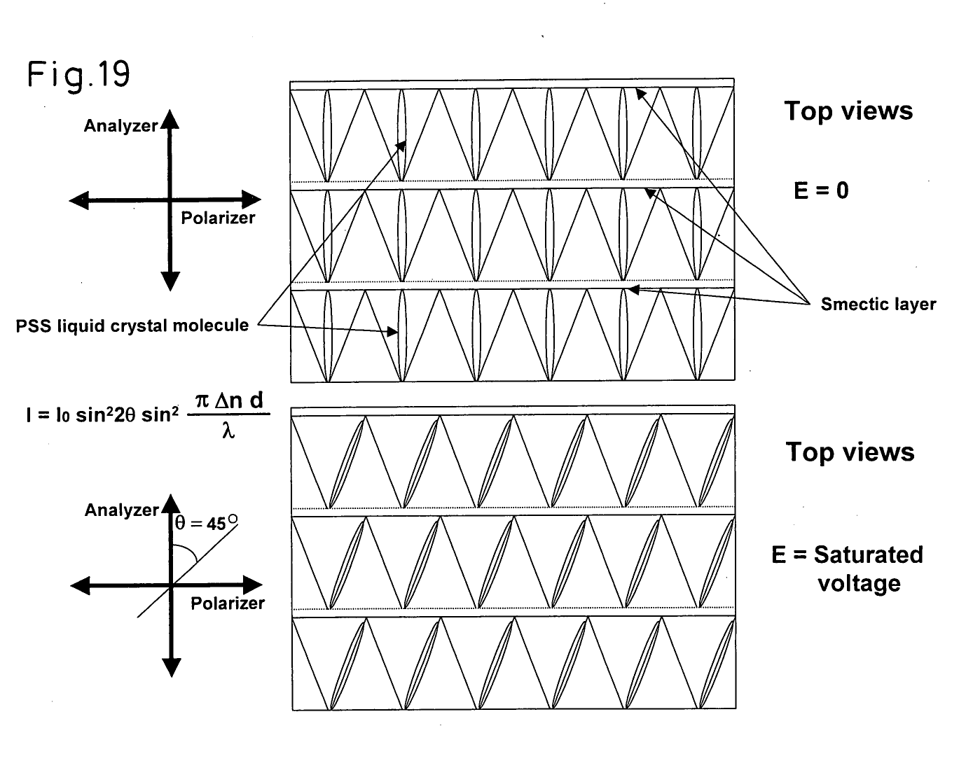

As described in above patent applications, one of the most unique points of the PSS-LCD is to have a specific liquid crystal molecular alignment as the initial alignment state. Using a certain kind of Smectic liquid crystal materials whose natural molecular n-director alignment has a specific tilt from the Smectic layer in conjunction with the strong azimuthal anchoring energy of the surface, this molecular n-director is forced to align layer normal. In another word, the least symmetrical molecule whose n-director has a certain tilt angle from the layer normal is aligned its n-director with layer normal by a specific artificial alignment force as illustrated in FIG. 19.

This initial alignment creates unique display performance at the PSS-LCD. This molecular alignment is similar with Smectic A phase whose n-director is normal to the layer, however, this-specific molecular alignment is realized only when the liquid crystal molecules are under the strong azimuthal anchoring energy surface with weaker polar anchoring surface condition. Therefore, these molecules are called as the Polarization Shielded Smectic or PSS phase. This patent application provides the fundamental method to give the most necessary condition to realize high performance PSS-LCDs. In order to realize this artificial n-director alignment at the PSS-LCD, strong azimuthal molecular alignment as well as weaker polar anchoring is the most necessary as described in the patent application.

The conventional nematic base LCDs use steric interaction based on Van der Waals force for their initial molecular alignment. The steric interaction gives a good enough initial molecular anchoring energy for the most of nematic liquid crystal molecules whose molecular anchoring is ordering n-director without necessity of n-director change artificially. Because of alignment nature of nematic liquid crystal molecules, their n-directors are always aligned in one same direction under the certain order parameter.

Unlike nematic liquid crystal molecules, Smectic liquid crystal molecules form a layer structure. This layer structure is not a real structure, but a virtual structure. Due to higher order parameter of Smectic liquid crystal than that for nematic liquid crystal, Smectic liquid crystal molecules have higher order molecular alignment forming their mass center alignment. Compared to natural molecular alignment of Smectic liquid crystals, nematic liquid crystals never align themselves keeping their mass center in a certain order such as that of Smectic liquid crystals.

The present invention is based on the basic research of the azimuthal anchoring energy and polar anchoring energy in terms of initial molecular n-director in Smectic phase of the least symmetrical Smectic liquid crystal molecules on a certain alignment surface. As one of the well known phenomena, the steric interaction based on Van der Waals interaction is much weaker than that is provided by Coulomb-Coulomb interaction. In the present invention, based on detailed investigations on the surface interaction (specifically, on the surface interaction between the least symmetrical Smectic liquid crystal molecules and a high polarity surface of the alignment layer), the enhancement of the Coulomb-Coulomb interaction between the Smectic liquid crystal molecules and a certain alignment surface, has been accomplished.

(Theoretical Analysis of the Surface Anchoring in the PSS-LCD)

The present invention should not restricted by any theory. The following description of a certain theory is based on the present inventor's knowledge and various investigations (inclusive of studies and experiments), and such a theory is described here only for the purpose of better understanding of a possible mechanism of the present invention.

In order to clarify necessary condition for the initial PSS-LC configuration, a free energy of the PSS-LC cell is considered based on the following expression. Three primary free energies are expressed as following:
(a) Elastic energy density: fₑₗₐₛ

$${f}_{elas} = \frac{B}{2} {( \frac{\partial ϕ}{\partial x} )}^{2} - {D}_{1} ( \frac{\partial ϕ}{\partial x} ) sin ϕ \qquad Equation ( 1 )$$

where B and D1 are Smectic layer and viscous elastic constant, respectively

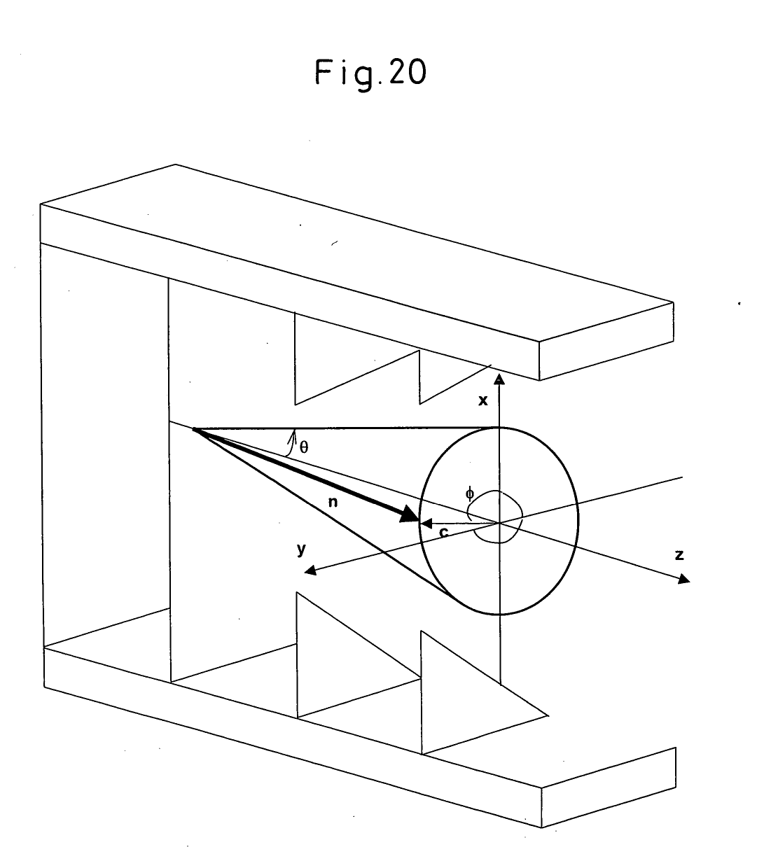

The coordinate system is set as shown in FIG. 20.

where φ is the azimuth presented in FIG. 20, x is set as cell thickness direction.
(b) Elastic interaction energy: f_{elec}

f_{elec}

$${f}_{elec} = - \frac{1}{2} Δ {ɛ ( \frac{\partial ψ}{\partial x} )}^{2} - \frac{1}{2} {{ɛ}_{⊥ 1} ( \frac{\partial ψ}{\partial x} )}^{2} - \frac{1}{2} {{ɛ}_{⊥ 2} ( \frac{\partial ψ}{\partial x} )}^{2} \qquad Equation ( 2 )$$

An electric field is given by the electrostatic potential φ: i.e.;

$$Ex = - \frac{\partial ψ}{\partial x} .$$

The dielectric anisotropy terms represented by

$$- \frac{1}{2} {{ɛ}_{⊥ 1} ( \frac{\partial ψ}{\partial x} )}^{2} and - \frac{1}{2} {{ɛ}_{⊥ 2} ( \frac{\partial ψ}{\partial x} )}^{2}$$

are for expressing contribution from quadra pole momentum.
(c) Surface interaction energy density: F_{surf}

According to Dahl and Lagerwall of their paper in Molecular Crystals and Liquid Crystals, Vol. 114, page 151 published in 1984, the surface interaction energy density is expressed as;
f_{surf}=θ(−γₚ⁰ cos φ⁰+γₚ¹ cos φ¹)+{γₜ⁰(θ sin φ⁰−α_{y}⁰)²+γₜ¹(θ sin φ¹±αₜ¹)²}+{γ_{d}⁰(θ cos φ⁰−α_{d}⁰)²+γ_{d}¹(θ cos φ¹+α_{d}¹)²} Equation (3)

Where θ is molecular tilt angle presented in FIG. 20, γp, γt, γd: are surface interaction coefficients, at is pre-tilt angle, and ad is the preferred direction angle from z-direction set in FIG. 20.

Regarding the surface interaction energy density, the required condition in terms of the initial molecular alignment condition of the PSS-LCD is θ=0 and f=3π/2 in FIG. 20. Taking account into these conditions, the equation (3) is now;
f_{surf}=γₜ⁰(αₜ⁰)²+γₜ¹(αₜ¹)²+γ_{d}⁰(α_{d}⁰)²+γ_{d}¹(α_{d}¹)² Equation (4)

Also, the preferred pre-tilt angle of the PSS-LCD is zero, then the equation (4) goes to;
f_{surf}=α_{d}²(γ_{d}⁰+γ_{d}¹) Equation (5)

Using the equations (1), (2), and (5), the total free energy per unit area F is;

$$\begin{matrix}F = {\int }_{0}^{d} ( {f}_{elas} + {f}_{elect} ) ⅆ x + {f}_{surf} \\ = {\int }_{0}^{d} \{ ( \frac{B}{2} {( \frac{\partial ϕ}{\partial x} )}^{2} - D \frac{\partial ϕ}{\partial x} sin ϕ ) + ( - \frac{1}{2} Δ {ɛ ( \frac{\partial ψ}{\partial x} )}^{2} - \\ \frac{1}{2} ( {{ɛ}_{⊥ 1} ( \frac{\partial ψ}{\partial x} )}^{2} - \frac{1}{2} {{ɛ}_{⊥ 2} ( \frac{\partial ψ}{\partial x} )}^{2} \} ⅆ x + {α}_{d}^{2} ( {γ}_{d}^{2} + {γ}_{d}^{1} )\end{matrix} \qquad Equation ( 6 )$$

here, the symmetrical surface anchoring: γd0=γd1, and φ+3p/2 are introduced in the equation (6);

$$F = {\int }_{0}^{d} \{ ( \frac{B}{2} {( \frac{\partial ϕ}{\partial x} )}^{2} - D \frac{\partial ϕ}{\partial x} ) - \frac{1}{2} ( Δ ɛ + {ɛ}_{⊥ 1} + {ɛ}_{⊥ 2} ) {( \frac{\partial ψ}{\partial x} )}^{2} \} \\ ⅆ x + 2 {γ}_{d} {α}_{d}^{2} \qquad Equation ( 7 )$$

As the initial state, E=0 is introduced to equation (7),

$${( \frac{\partial ψ}{\partial x} )}^{2} = 0 \\ F = {\int }_{0}^{d} \{ \frac{B}{2} {( \frac{\partial ϕ}{\partial x} )}^{2} - D \frac{\partial ϕ}{\partial x} \} ⅆ x + 2 {γ}_{d} {α}_{d}^{2} \qquad Equation ( 8 )$$

here, the preferred direction angle d_{d} is set to z-direction, and viscous elastic constant D can be expressed as;

$$D = \frac{η}{2} {( \frac{\partial ϕ}{\partial x} )}^{2} \qquad Equation ( 9 )$$

To minimize F;

$$\frac{B}{2} {( \frac{\partial ϕ}{\partial x} )}^{2} = \frac{\partial ϕ}{\partial x} \qquad Equation ( 10 )$$

α_{d}=0 Equation (11)

Therefore, it is clear that the PSS-LC molecule should be parallel to z-direction shown in FIG. 20. Also the equation (10) leads to the condition that the PSS-LC molecules need to stack from the bottom to top surfaces in uniform to meet with the specific Smectic layer elastic constant and liquid crystal molecular viscosity in the same layer.

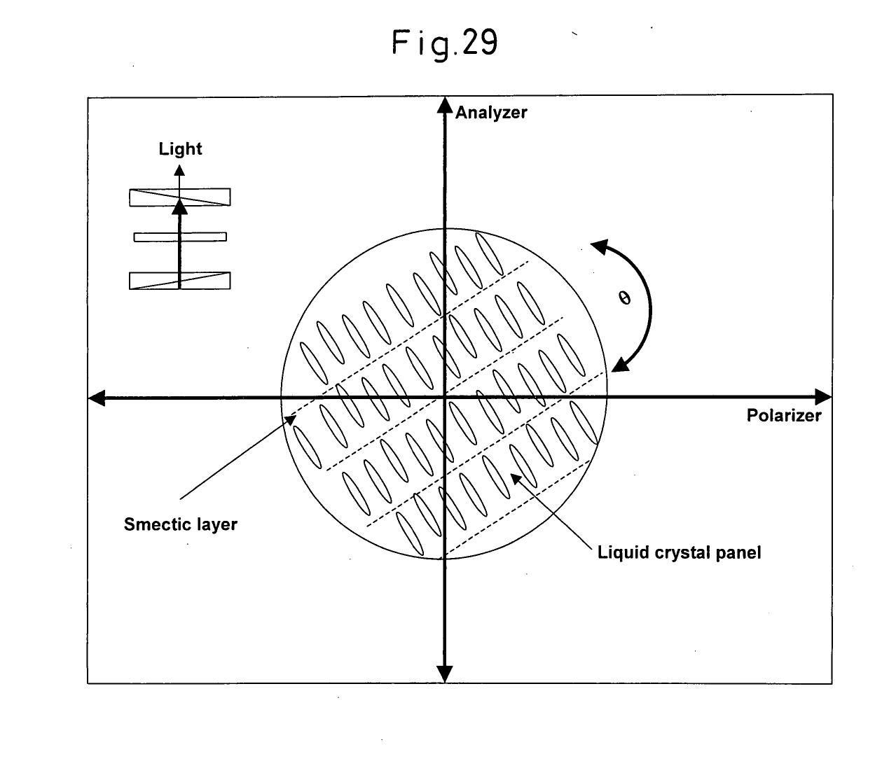

As described above, the intrinsic concept of the present invention is based on the enhancement of Smectic liquid crystal molecular director, which has a tilt angle from Smectic layer normal, along with set alignment direction such as buffing direction. Using a certain category of Smectic liquid crystal molecules whose molecular directors have a tilt angle to the Smectic layer normal as a bulk shape, the enhancement of molecular director alignment forces the Smectic liquid crystal molecular directors along with pre-set alignment direction. This enhancement enables the Smectic liquid crystal molecular directors to align perpendicular to the Smectic layer as illustrated in FIG. 29.

The unique electro-optical performance of the PSS-LCD can be created by this specific molecular alignment of the Smectic liquid crystal molecules. One of these unique characteristic properties of the PSS-LCDs may be its relationship between a panel gap and drive voltage.

In the case of most of known LCDs, they need higher drive voltage by increasing their panel gap. Because of increase of panel gap, the required applied voltage needs to be increased to keep the strength of the electric field.

In the PSS-LCD according to the present invention, however, sometimes needs less voltage, when the panel gap increases. Due to requirement of strong azimuthal anchoring energy at the PSS-LCD panel, increase in panel gap provides weakening of anchoring in the liquid crystal molecules in the panel, resulting in lower voltage for the driving. This fact is also one of the proofs of the above described interpretation of the PSS-LCDs.

(Practical Method to Enhance Coulomb-Coulomb Interaction)

Because of existence of a layer structure of the Smectic liquid crystals, a specific balance between the layer structure and the alignment interface is always of great concern in terms of a clean molecular alignment. In particular the case of the PSS-LCD which requires strong azimuthal anchoring energy, how the strong anchoring energy is given to the liquid crystal molecules without disturbing their native layer structure is the most important.

As discussed theoretically in previous section, strong azimuthal anchoring is the most necessary to realize the PSS-LCD configuration. The inventor had experimental efforts to find out the practical method to give rise the strong anchoring energy without disturbing the formation of the native liquid crystal layer structure. In the course of the experimental efforts, it has been found that emphasizing some specific liquid crystal molecules out of the total PSS-LC mixture is one of the effective methods to provide strong enough anchoring energy in accordance with forming the layer structure. Due to the strong self-formation power of the layer structure in Smectic liquid crystals, it was not easy to give rise strong enough anchoring energy. If the surface anchoring is too strong, the formed layer structure of the Smectic liquid crystals is distorted, or in the worst case, destroyed. Prioritizing the clean layer structure always results in failure of the PSS-LC molecular alignment that could not form the Smectic liquid crystal molecular n-director alignment is normal to the layer. The most important to obtain clean molecular alignment in the PSS-LCD is to provide strong azimuthal anchoring energy with weak adhesive anchoring energy, which is the polar anchoring energy, to the liquid crystal molecules.

Therefore, the PSS-LCD accepts inorganic alignment materials as long as they provide strong enough azimuthal anchoring with weak polar anchoring energy. This provides significant advantage to the PSS-LCD for projector panel applications.

Due to strong light flux, most of current polymer base alignment layers have a problem in their life time. However, due to requirement of rather strong polar anchoring for most of conventional nematic base LCDs, inorganic alignment layer has been not easy in their application to projector panels. On the contrary, the PSS-LCDs requires no particular polar anchoring energy, rather than requiring polar anchoring energy, the PSS-LCDs require weak or even no polar anchoring energy, but strong azimuthal anchoring energy. Therefore, most of inorganic base alignment layers provide very effective molecular alignment to the PSS-LCDs. In other words, in the present invention, it is possible to use any inorganic base alignment layer without particular limitation, as long as it provides a strong azimuthal anchoring energy.

(Some Features of PSS-LCD According to the Present Invention)

(Capacitance at Each Display Pixel)

One of the most distinguished features of the PSS-LCD is its smaller capacitance at each display pixel such as a pixel at amorphous silicon thin film transistor (hereinafter, referred to as “a-Si TFT”) pixel pad. In an a-Si TFT LCD, smaller capacitance of the pixel, which comes from the dielectric constant of the liquid crystal material, is one of the greatest concerns in terms of image performance. If the pixel capacitance is large, the transient voltage at the pixel changes very quickly, resulting in unfavorable image performance such as flicker, image retention. Some of the large capacitance of the pixel is absorbable by sophisticated design of a-Si circuit, however, very complicated pixel design has strong tendency to reduce a-Si TFT manufacturing yield. Therefore, smaller capacitance is one of the most important factors to provide higher image performance and lower manufacturing cost.

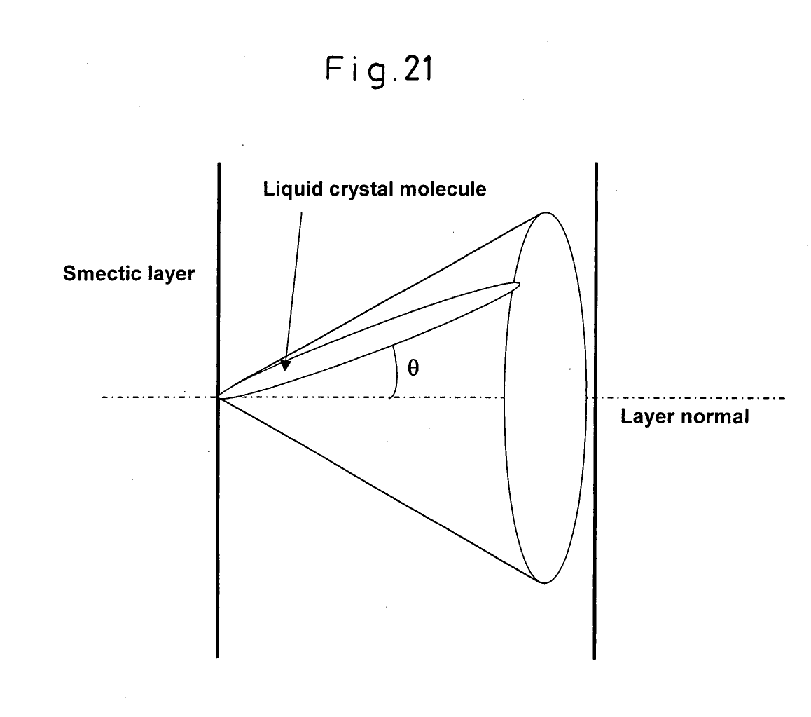

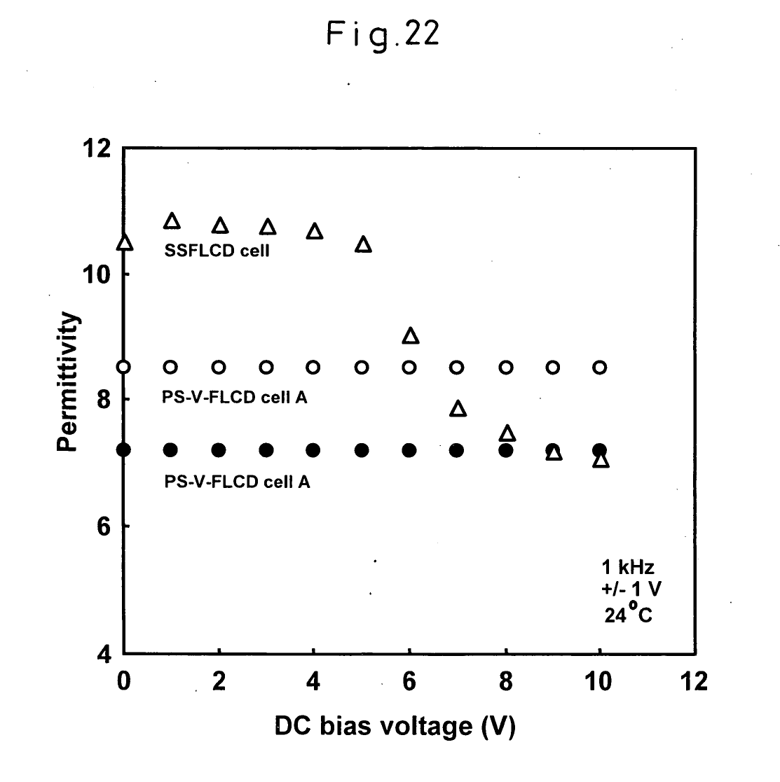

Nematic liquid crystal displays based on dipole momentum torque need to have large enough dipole momentum to reduce the drive voltage and obtaining faster optical response. Because the low enough drive voltage and faster optical response are the most necessary requirement for practical LCDs, nematic base LCDs have sacrificed complicated design of TFT array and manufacturing process efforts. On the contrary, the PSS-LCD has smaller capacitance than that for nematic base LCDs. In general, the pixel capacitance of the PSS-LCD is at least half of the nematic LCDs, some times it is quarter of the nematic LCDs. Thanks to quadra-pole momentum base torque and very short distance in liquid crystal molecular move as illustrated in FIG. 21, the PSS-LCD is drivable with smaller pixel capacitance with fast enough optical response. One of the actual examples of the capacitance is measured in FIG. 22.

As shown in FIG. 22, dielectric constant of the PSS-LCD is smaller than that for nematic base LCDs. Moreover, the dielectric constant of the PSS-LCD is much smaller than that for conventional SSFLCDs. Due to spontaneous polarization of the SSFLCD, an effective dielectric constant of the SSFLCD is much larger than that for nematic LCDs, resulting in too much burden for a-Si TFT drive. Actually, conventional a-Si TFT is not able to drive SSFLCDs due to too large requirement of electron charges for spontaneous polarization switch of the SSFLCD. Therefore, the small capacitance of the PSS-LCD is one of the most distinguished features to differentiate its significance both from SSFLCDs and nematic base LCDs.

(Change in Capacitance Before and After Optical Switching)

The other distinguished feature of the PSS-LCDs from conventional SSFLCDs and nematic base LCDs is smaller change in capacitance before and after the optical switching of the liquid crystals. Similar to above discussion, smaller change at pixel pad at TFT array is of most important requirement for TFT-LCDs in terms of stable image performance without showing flicker and image retention.

A transient voltage drop at TFT, which is well known as “feed through voltage”, is inevitable at TFT-LCDs as long as the liquid crystal material has different capacitance before and after the optical switching. This feed through voltage is the root cause to create flicker and image retention. However, the different capacitance before and after the optical switching is very intrinsic nature of the liquid crystal, in particular for dipole momentum base and spontaneous polarization base liquid crystals.

In order to avoid flicker and image retention, conventional TFT-LCDs put some varieties of method to minimize the problems. However, the most intrinsic method is to use small or almost no change in capacitance materials. Despite many efforts to minimize this change in capacitance, the change in capacitance before and after the optical switching is very intrinsic nature of the conventional liquid crystal materials both in nematic base and ferroelectric liquid crystals as described above.

The PSS liquid crystal material which uses quadra-pole momentum does not need to have large capacitance change because of its very small dielectric constant and very short distance to move to create large enough birefringence for high contrast ratio at LCDs. The actual capacitance change before and after the optical switching of the PSS-LCDs is compared to that of conventional SSFLCD in FIG. 22.

In FIG. 22, in order to induce optical switching, DC bias voltage is applied to sample cells. The applied DC voltage is over the threshold voltage, optical switching is created. In FIG. 22, this threshold voltage for the PSS-LCD panels is around 0.5V, and that for the SSFLCD panel is around 6V. As shown in FIG. 22, the SSFLCD shows significant capacitance change. On the contrary, the PSS-LCD panels do not show any significant change in capacitance. This very small, or almost no change in capacitance before and after optical switching is the very distinguished characteristic properties of the PSS-LCDs. As long as the inventor has known so far, this small or almost no change in capacitance has not known in any LCDs except for the PSS-LCDs.

The measurement method of the capacitance in FIG. 22 is following.

(Measurement Method of Capacitance)

Using 35 mm square sized non-alkaline glass substrate, alignment layer is formed on the surface of the glass. The glass substrate has 15 mm diameter round shape ITO electrode at the center of the glass substrate. The formed alignment layer aligns PSS liquid crystal molecules in proper configuration. One of the typical alignment method is using specific poly-imide layer with mechanical buffing at the top surface of the poly-imide, which is well known and industrial standard process. The typical panel gap of the PSS-LC panel is 2 micron. For the measurement of FIG. 22, average diameter of 1.8 micron of silicon dioxide balls are used as spacer balls. After the perimeter area is sealed by epoxy glue, liquid crystal materials are injected into the panel and obtains the liquid crystal filled panel. For the measurement of the capacitance or dielectric constant of the filled cell, 1 kHz, ±1V of square waveform is applied to the sample cells as prove voltage. Bias DC voltage is also applied to the sample cell. This DC bias voltage induces optical switching of the sample cell, once the voltage is large enough to switch the n-director of the liquid crystal molecules.

### Desirable Embodiment of the Present Invention

The core concept of the present invention is to emphasize initial molecular n-director normal to the Smectic liquid crystal layer. The role of this surface emphasis is to provide strong enough Coulomb-Coulomb interaction between the PSS liquid crystal molecules and the specific surface in terms of giving rise to azimuthal anchoring and keeping relatively weak polar anchoring to the PSS liquid crystal molecules.

As described above, some desirable embodiments of the present invention is followings:

(1) Use the specific Smectic liquid crystal materials whose molecular n-directors have some tilt angle from their Smectic layer normal illustrated in FIG. 21.

(2) Those Smectic liquid crystals belong to Smectic C, Smectic H, Smectic I phases and other least symmetrical molecular structure phase group. Chiral Smectic C, Chiral Smectic H, Chiral Smectic I phases also satisfy the necessary criteria for the PSS-LCD performance as described in US patent application US-2004/0196428 A1.

(3) Applying strong azimuthal anchoring as well as weaker polar anchoring energy, the natural n-director tilt from the Smectic layer normal is forced to be layer normal. As the result of this function, the PSS liquid crystal materials generally show following phase sequence:

Isotropic—(Nematic)—Smectic A—PSS phase—(Smectic X)—Crystal. Here, the blanket “( )” means not always necessary.

(4) One of the distinguished characteristic properties of the PSS-LCD is keeping same extinction angle between that in Smectic A phase and in the PSS phase. Extinction angle of the Smectic C phase is always different from that of Smectic A phase due to the molecular tilt angle from layer normal of the Smectic C phase. Therefore, the same extinction angle between Smectic A phase and the PSS phase is the unique property of the PSS phase.

(5) As the result of above function, the aligned PSS-LC cell shows a small anisotropy of dielectric constant such as less than 10, more preferably less than 5, most preferably less than 2. The anisotropy of dielectric constant is a function of measured frequency in the PSS-LCD. Due to the use of quadra-pole momentum unlike dipole-momentum for most of conventional LCDs, the anisotropy of dielectric constant is dependent on frequency of the prove voltage. Here the preferable value of the anisotropy of dielectric constant should be measured at 1 kHz of rectangular waveform. Unlike dipole-momentum coupling of the conventional LCDs, The PSS-LCD needs relatively small anisotropy of dielectric constant because of enhancement of quadra-pole momentum. This small anisotropy of dielectric constant is very helpful in drivability of TFTs. Thanks to smaller dielectric load for the TFT compared to that of conventional LCDs; the PSS-LCD has relatively small influence of Para-capacitance, which creates voltage shift for the TFT. Therefore, the PSS-LCD has wider drive window for conventional TFT arrays.

For example, one of the typical PSS-LC material shows anisotropy of dielectric constant of 1.5 using above measuring condition. This provides less than quarter of capacitance in the LCD panel compared to that of conventional TN-LCD panel. This means that the PSS-LCD realizes smaller feed through voltage in TFT-LCDs, resulting in stable and better image performance than that of conventional nematic base TFT-LCDs. FIG. 22 directly proves no involvement of spontaneous polarization and extremely small change in its dielectric constant before and after the optical switching of the PSS-LCD. From the result of FIG. 22, it is obvious that the PSS-LCD uses very small anisotropy of dielectric constant for its drive force. This is also one of the proofs of direct involvement of quadra-pole momentum in the PSS-LCD.

(6) The prepared PSS-LCD cell satisfying above conditions show specific direction of molecular tilt dependent on the direction of externally applied electric field. Due to the quadra-pole coupling, the PSS-LC molecule tells difference of the direction of applied electric field. This is one of the very different characteristic properties of the PSS-LCD. All of conventional nematic base LCDs using birefringence mode utilize dipole-momentum coupling, therefore, they do not tell the difference of the direction of applied electric field. Only the difference in potential of applied voltage drives those LCDs. The PSS-LCD molecules change their tilt direction by detecting the direction of applied voltage, although they do not have spontaneous polarization. This is also one of the supporting theories of quadra-pole momentum base drive of the PSS-LCD.

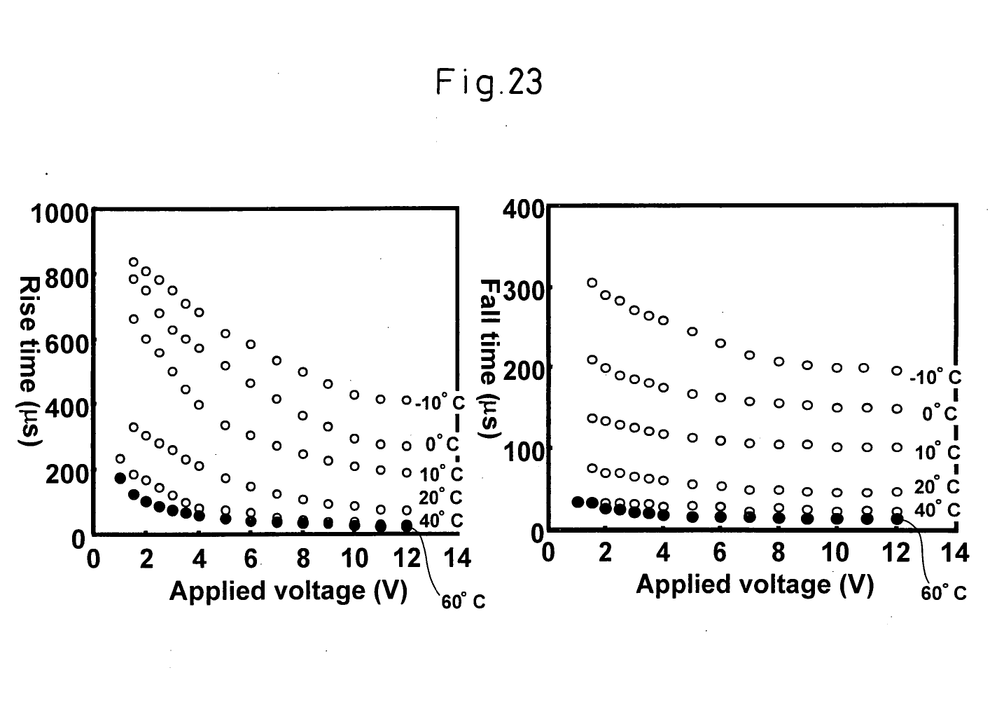

In spite of using very small anisotropy of dielectric constant based on quadra-pole momentum, the PSS-LCD shows extremely fast optical response such as sub-mille seconds both in rise and decay times. The major reason of the extremely fast optical response is its small distance of molecular tilt along the cone edge to create large enough birefringence as illustrated in FIG. 29. Unlike all of nematic base LCDs, the PSS-LCD requires very small distance in the molecular position change to create large enough birefringence. The very uniform molecular tilt along the cone edge shown in FIG. 29 also realizes extremely fast optical response such as shown in FIG. 23.

(Phase Sequence and Light Transmittance Situation)

The phase sequence and light transmittance situation at each phase are following.

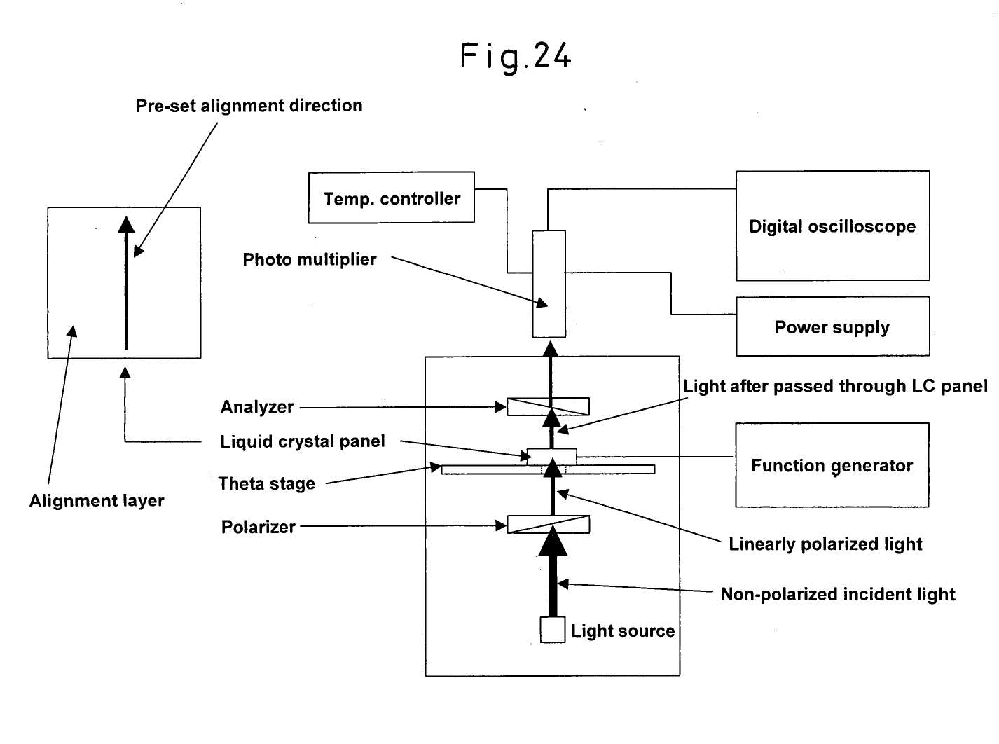

Under the crossed Nicole, a liquid crystal panel presents its specific light transmittance at each phase. In this situation, the direction of the pre-set liquid crystal molecular alignment is designed as illustrated in FIG. 24.

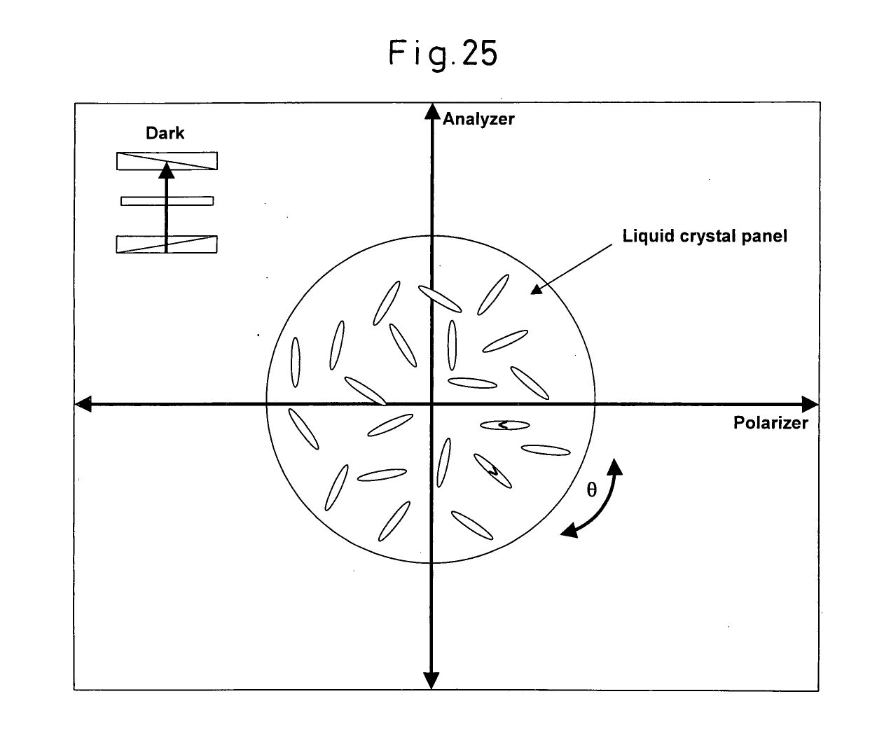

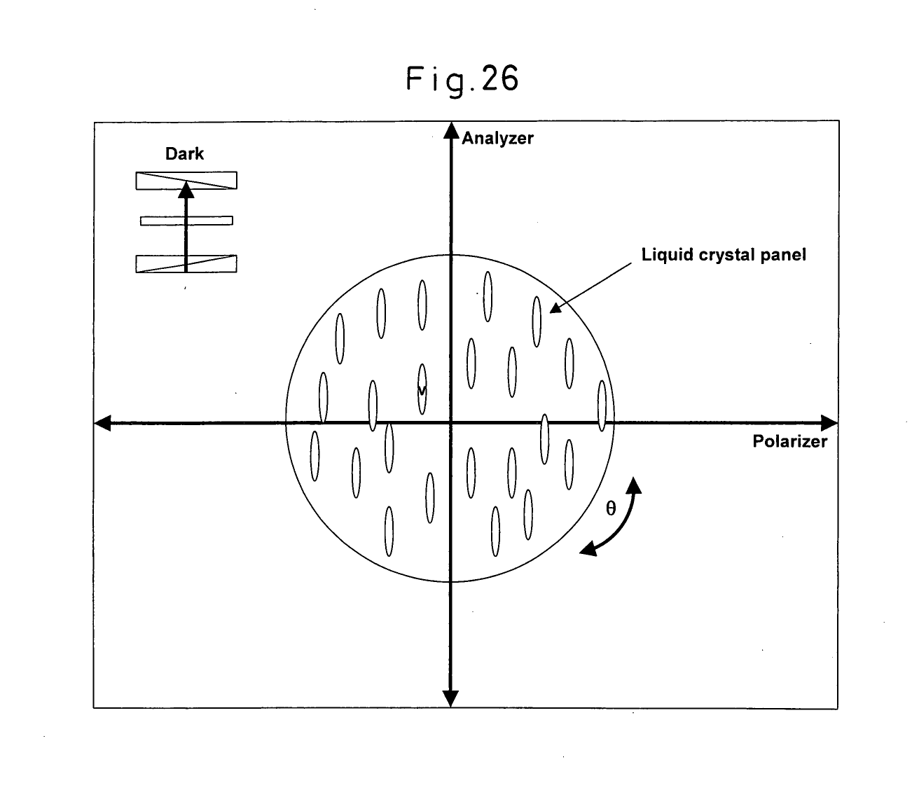

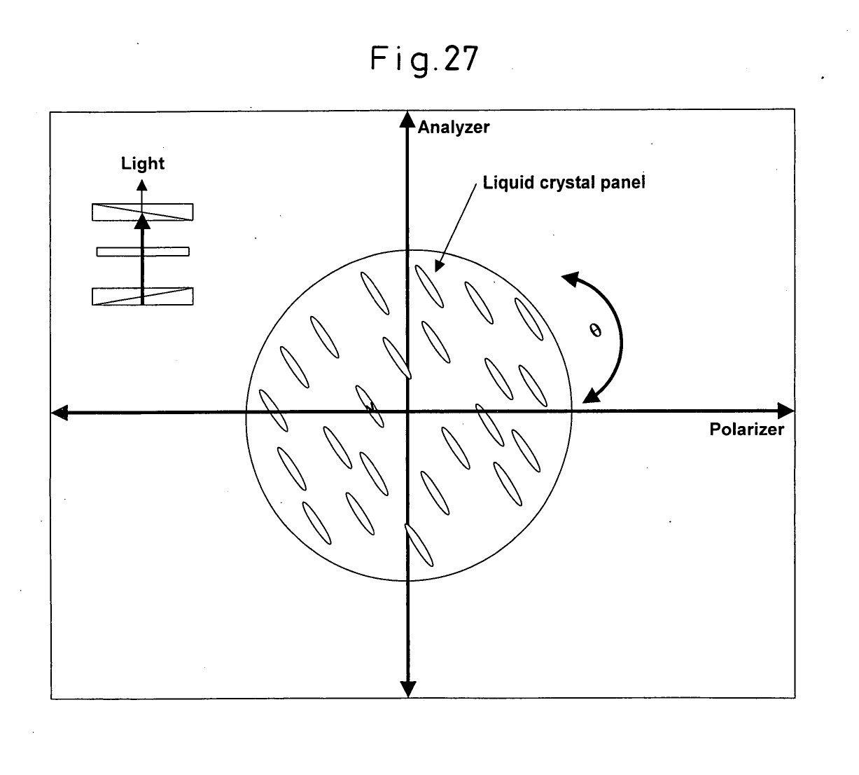

At the isotropic phase, directions of liquid crystal molecules are random, so that incident linearly polarized light passes through the liquid crystal panel straightforwardly, resulting in “dark” state as shown in FIG. 25 regardless panel angle to the incident light. By decreasing the ambient temperature, the liquid crystal goes into nematic phase or chiral nematic phase depending on achirality or chirarity of the liquid crystal. At the nematic phase, all of liquid crystals align their n-director to the pre-set alignment direction. In this situation, the liquid crystal panel does not allow the linearly polarized light passing through the analyzer due to no polarization rotation by the liquid crystal layer. Therefore, this shows “dark” state as long as the pre-set liquid crystal molecular alignment direction is parallel to the polarizer direction as shown in FIG. 26. Once, the liquid crystal panel is rotated, the incident linearly polarized light changes its polarization, resulting in light leakage as illustrated in FIG. 27.

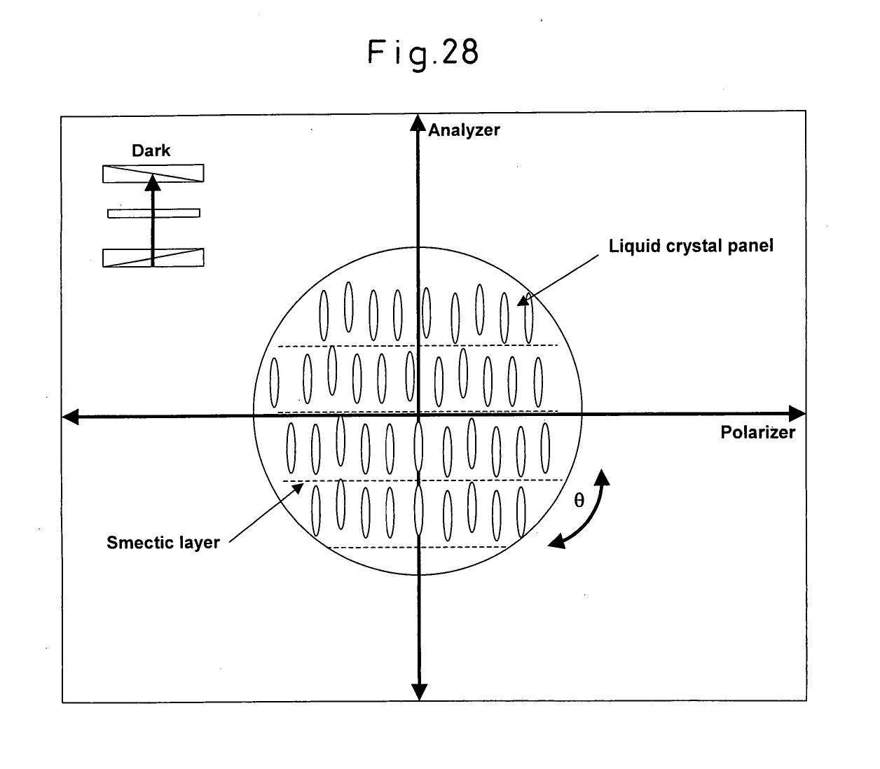

Further reduction of ambient temperature gives rise to next phase to the liquid crystal panel. The consequent liquid crystal phase is smectic A phase. Smectic A phase has a layer structure in its liquid crystal molecular configuration as illustrated in FIG. 28. This phase also allows incident linearly polarized light pass through the smectic liquid crystal layer straightforwardly, resulting in “dark” state. Like the nematic phase, the smectic A phase also shows some light leakage, when the panel is rotated shown in FIG. 29.

This consequent phase sequence is common with conventional smectic liquid crystals and the PSS liquid crystals. However, under the smectic A phase in terms of phase sequence along with ambient temperature, the light transmittance behavior is different between conventional smectic liquid crystals and the PSS liquid crystals.

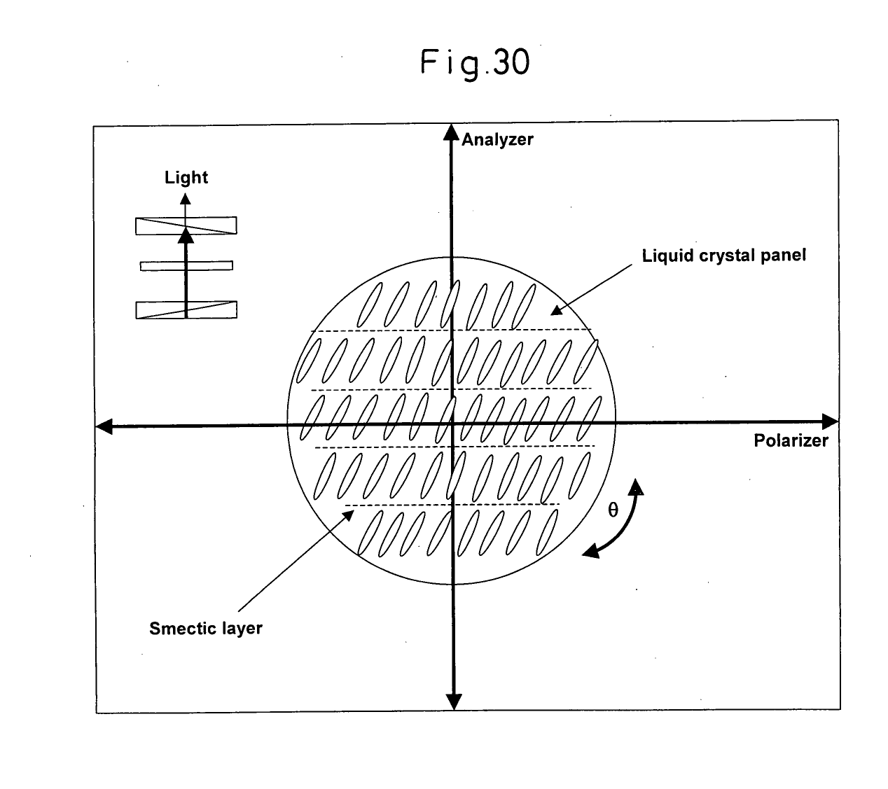

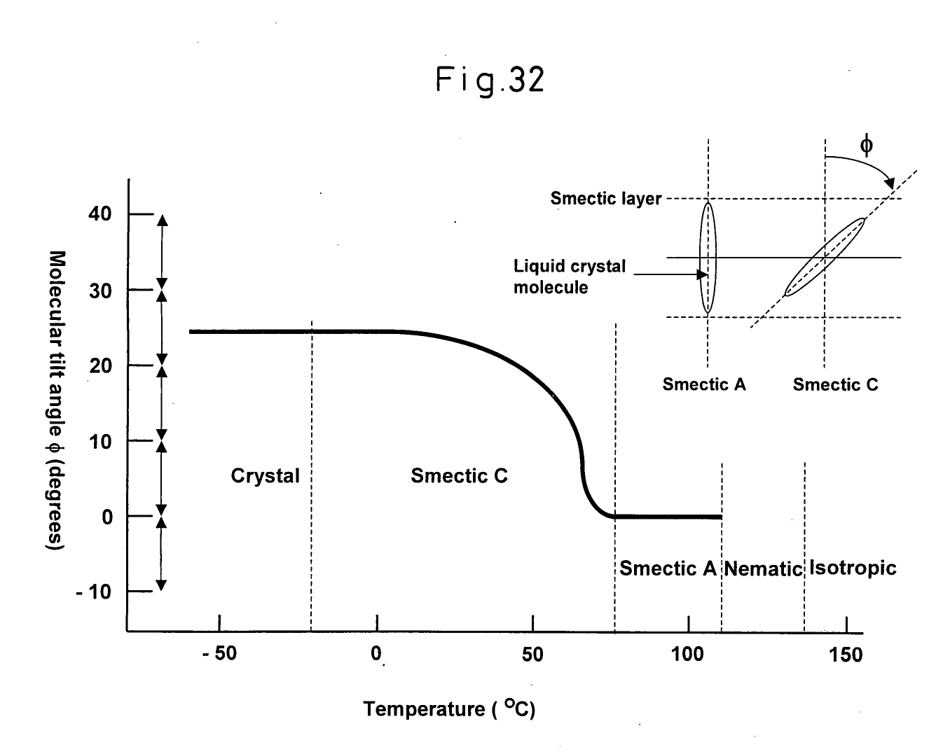

In the conventional smectic liquid crystals, next phase is smectic C phase or chiral smectic C phase, depending on its achirality or chirality as illustrated in FIG. 30. In the smectic C phase, n-director of the liquid crystal molecule tilts from the layer normal, resulting in “light leakage” state. The tilt angle is a function of ambient temperature with the second order phase change, which means the tilt angle gradually increases with decrease of ambient temperature as illustrated in FIG. 32. Therefore, the light intensity of the leaked light from the panel is dependent on ambient temperature. Until the molecular tilt angle saturates, the leaked light intensity increases in same profile with FIG. 32 in terms of increase of light intensity with the decrease of ambient temperature. This light leakage at the smectic C phase is the result of molecular tilt from the layer normal, which is quite common in conventional smectic C phase.

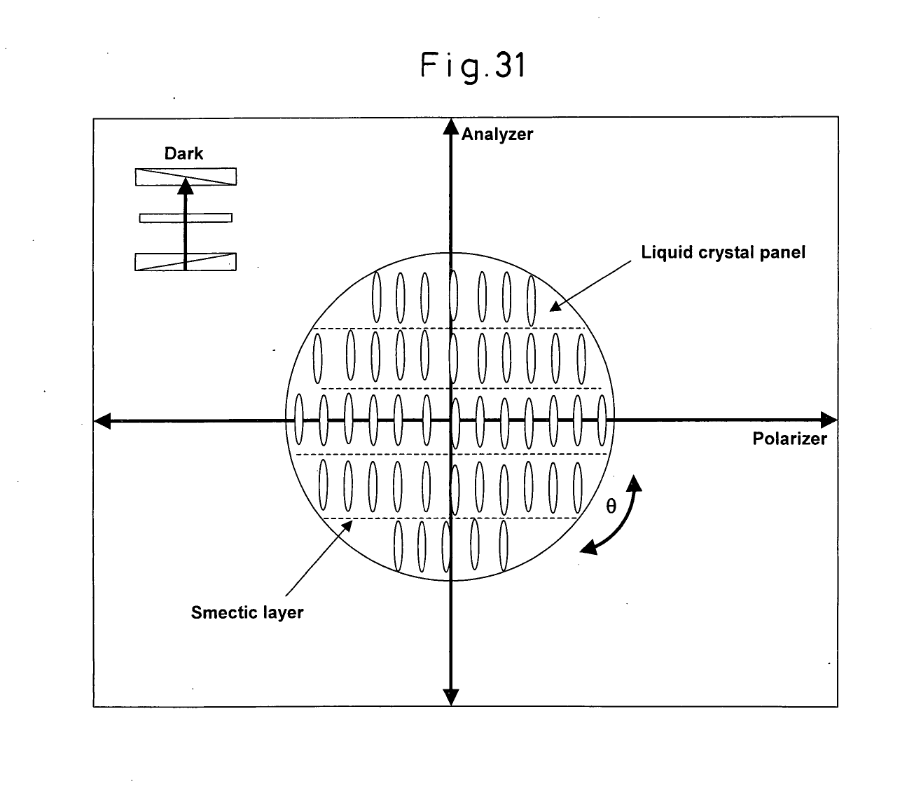

On the contrary, in the present invention which is the PSS-LC phase consequent to smectic A phase does not show the molecular tilt from the layer normal. In the PSS-phase, the n-director of the liquid crystal still keeps its direction normal to the layer. Therefore, the PSS phase does not show light leakage shown in the smectic C phase. Because of the PSS-LC's specific molecular direction, the light transmittance situation is same with that of smectic A phase in general as shown in FIG. 31.

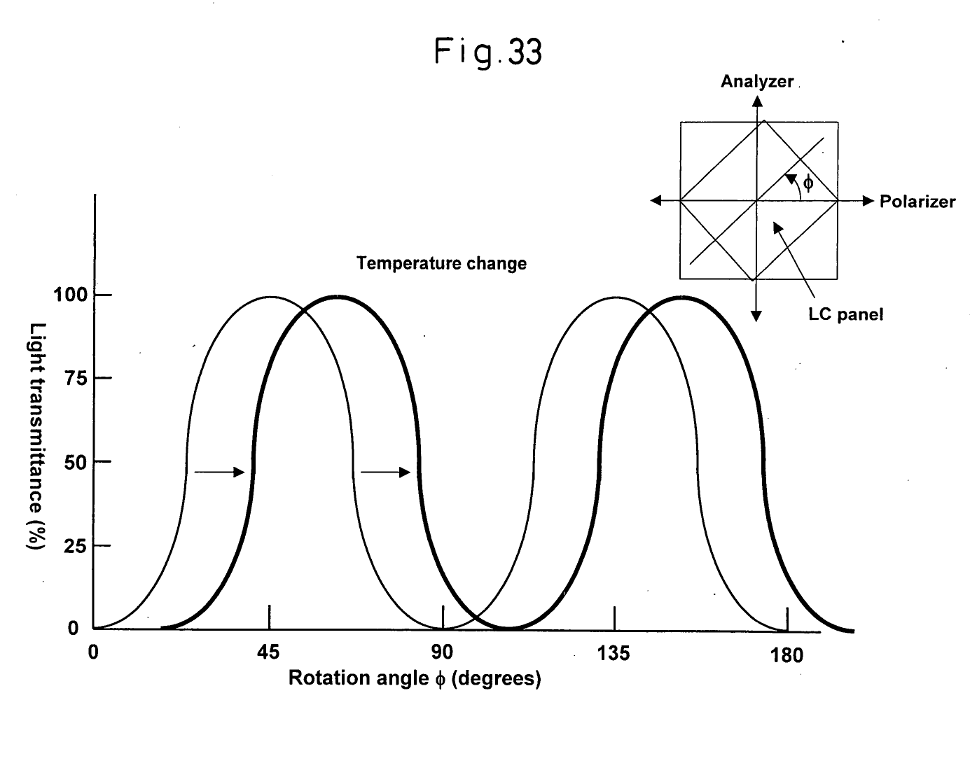

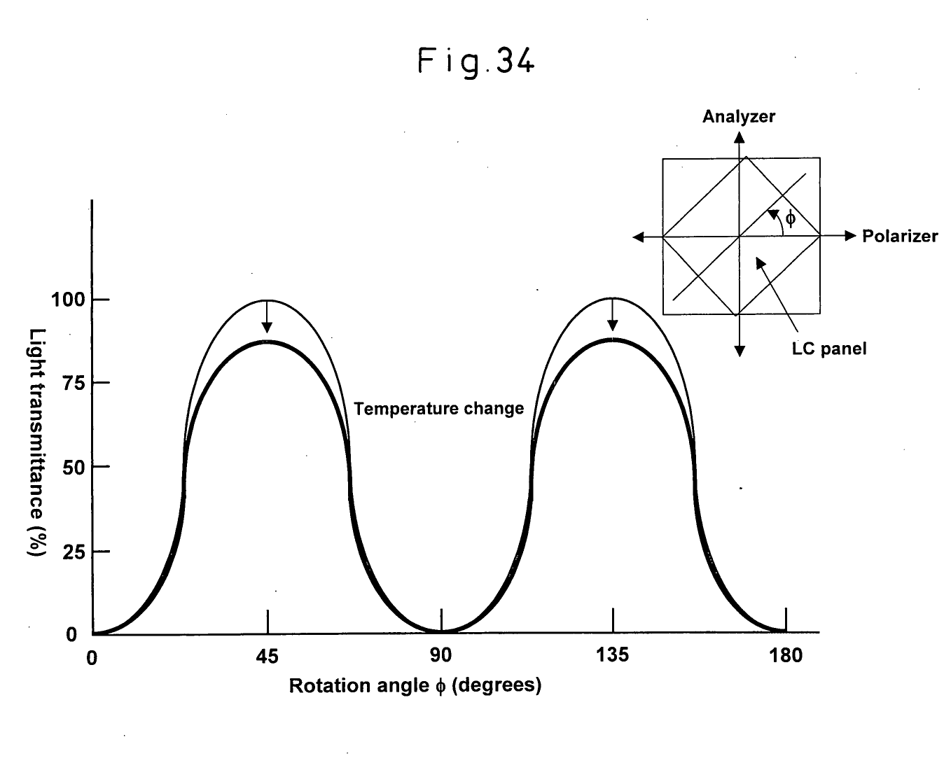

Since the difference in n-director direction between conventional smectic C phase and the PSS-LC phase, temperature dependence of the light intensity by rotation of the liquid crystal panel under the crossed Nicole is compared in FIGS. 23 and 24, respectively. Due to temperature dependent tilt angle of conventional smectic C phase, the extinction angle of the panel shifts depending on ambient temperature as shown in FIG. 33. Unlike the conventional LCD panel, the PSS-LCD does not show temperature shift in its extinction angle. The light intensity at “bright” state is dependent on ambient temperature, however, the extinction angle does not show any shift from its original angle as shown in FIG. 34.

Those Figures as clearly tell the difference between the conventional smectic C phase liquid crystals and the PSS-LCs in their optical situation.

(Difference Between Smectic C Phase and PSS-LC Phase)

There is another obvious visual difference differentiate conventional smectic C phase and the PSS-LC phase.

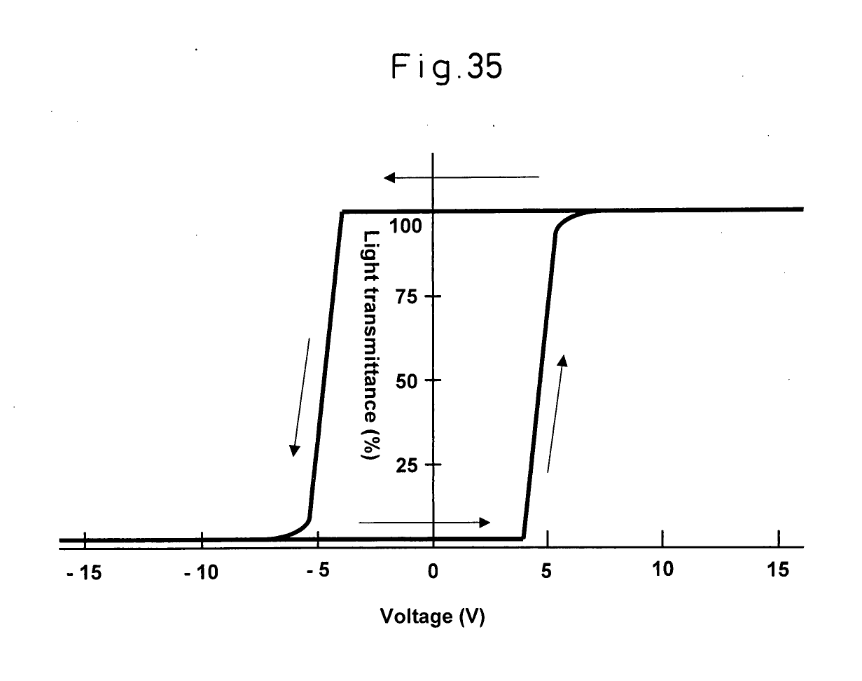

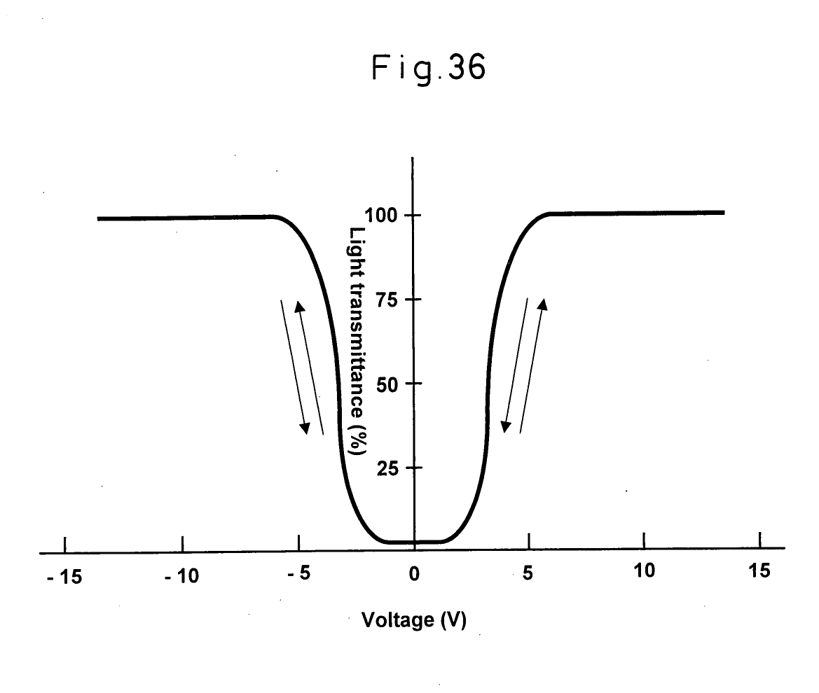

Due to the PSS-LCD performance, the voltage to transmittance curve (V-T curve) of the PSS-LCD is very different from that of conventional smectic C, or chiral smectic C phase. The dependence of applied electric field strength of the PSS-LCD presents an analog response V-T curve as shown in FIG. 35. In contrast, a conventional chiral smectic C phase liquid crystal display shows hysteresis in its V-T curve as illustrated in FIG. 36. Due to spontaneous polarization of the conventional chiral smectic C phase liquid crystal panel, its electro-optical response is dependent on the polarity of the applied voltage instead of the strength of the electric field. In short, the electro-optical response of the conventional chiral smectic C phase panel is not the applied electric field response, but the polarity response. In terms of electro-optical response, the PSS-LCD shows same optical response with nematic base LCDs whose electro-optical response is based on a coupling between the applied electric field and induced polarization of the liquid crystals.

(Novel Gray-Scale Display Method Adapted to a PSS-LCD)

The mode in which the present invention adapted to a PSS-LCD will be described from the viewpoint of the theory proposed by the present inventor.

According to the results of the theoretical discussion on the electro-optic response characteristic of the PSS-LCD performed by the present inventor, the orientation of liquid-crystalline molecules changes along with a change in a gradient at which a voltage pulse to be applied to a liquid-crystal display panel rises, that is, a change in a dV/dt value. Consequently, as far as a polarization shielded smectic liquid-crystal display (PSS-LCD) is concerned, the rising characteristic of an applied voltage expressed as the dV/dt value is, in principle, controlled in order to change a characteristic curve showing a voltage applied to the liquid-crystal display panel versus a transmittance (V-T curve). A quite precise measurement must be performed in order to directly detect a quadra-pole momentum induced in the liquid-crystal display panel. The direct detection of the quadra-pole momentum is not easy to do. However, an electro-optic response which liquid crystals make based on the quadra-pole momentum can be inferred reasonably.

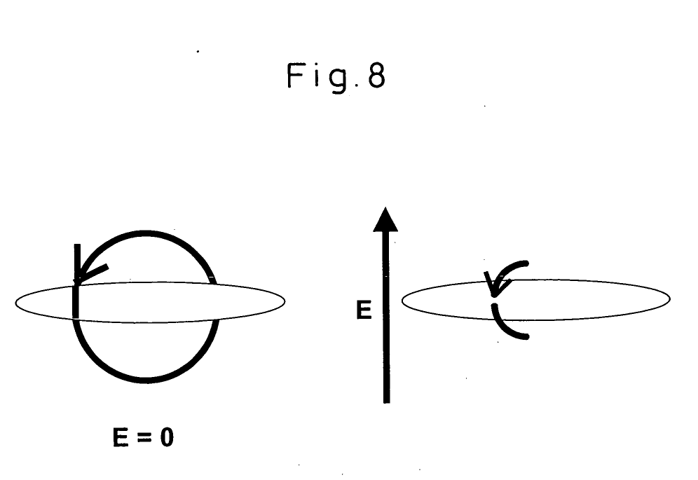

In a PSS-LCD employing liquid crystals such as smectic C phases in which the symmetry of a molecular structure is of the lowest level, a quadra-pole momentum exhibited by each of liquid-crystalline molecules is coupled with an applied external electric field. This restricts the rotation about the major axis of a molecule. Due to the restriction imposed on the rotation about the major axis, the quadra-pole momentum of a molecule expands. The expanded quadra-pole momentum and external electric field are coupled to each other more strongly. Consequently, a speed at which the orientation of the molecule is changed, that is, a response speed is accelerated. At this time, if a dV/dt value is small, the expansion of the quadra-pole momentum is limited and the response speed is low. In contrast, if the dV/dt value is large, the expansion of the quadra-pole momentum is intensified and the response speed is very high. FIG. 8 qualitatively shows the foregoing phenomenon.

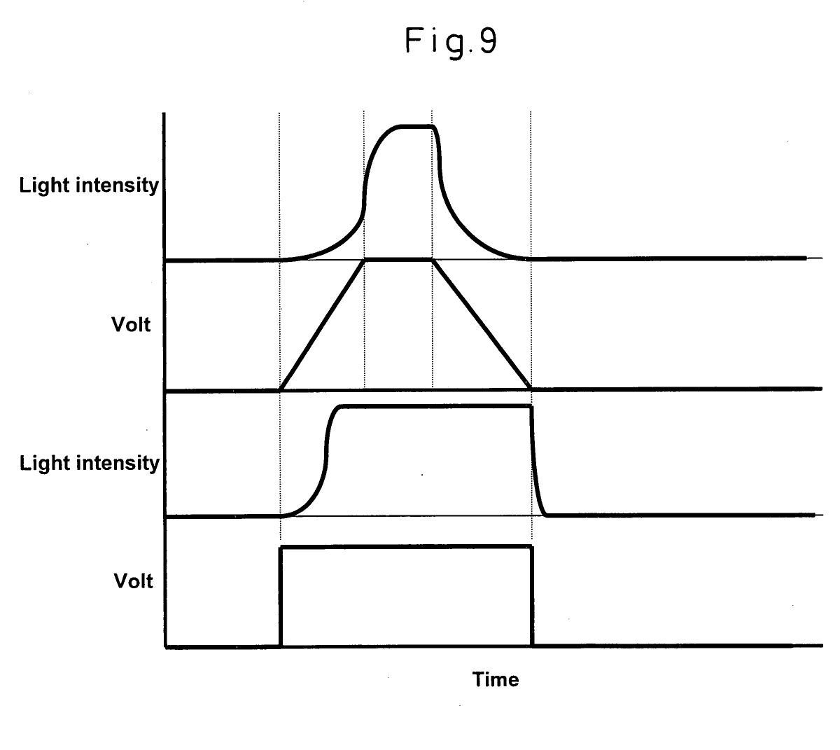

Compared with a conventional LCD, in a PSS-LCD that quickly responds to an applied voltage, when a dV/dt value corresponding to a gradient of an applied voltage is controlled, if a method of controlling a cumulative quantity of light transmitted during successive turn-on times within one frame is adopted, precise gray-scale control whose concept is shown in FIG. 9 can be achieved.

Referring to FIG. 9, a PSS-LCD that requires 150 μs as a rise time is employed, and a frame frequency is 60 Hz. In this case, one frame time is 16.7 ms, and a dV/dt value is controlled during the remaining 16.55 ms in order to control the rising characteristic of the PSS-LCD. Thus, a cumulative quantity of light transmitted during one frame is continuously controlled.

To be more specific, a dV/dt value is determined at 1024 steps and the shortest controllable time is regarded as approximately 16 μs. A typical driving voltage to be applied to a thin-film transistor (TFT), that is, 5 V can be readily controlled during 16 μs. Since the dV/dt value is continuously controlled, the response time or rise time required by the PSS-LCD changes uniquely along with a change in the dV/dt value. An integral value of amounts of light transmitted within one frame can be controlled at 1024 steps. According to this method, since the dV/dt value can be controlled during 8 μs within one frame, 2048 shades, that is, eight billion tones or more can be reproduced.

(Extension of the Novel Gray-Scale Display Method Implemented in a PSS-LCD)

As mentioned above, when a PSS-LCD and a dV/dt control method are adopted, eight billion tones or more can be displayed. When a digital gray-scale display method of controlling a turn-on time continuously within one frame time is also adopted, shades represented by twelve bits for each color, that is, 680 billion tones can be displayed.

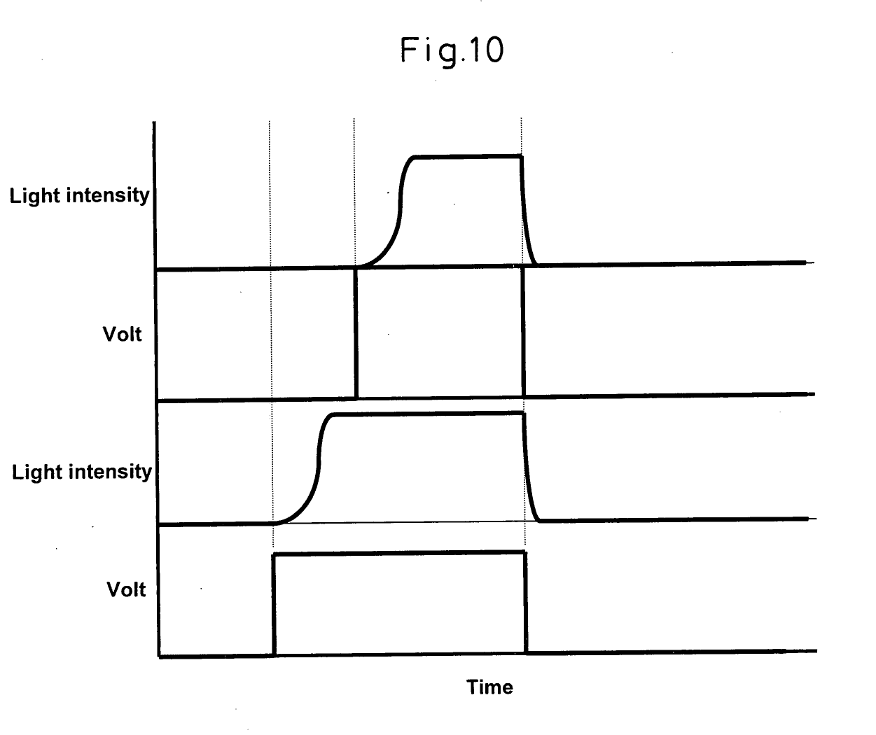

A concrete example of the display method is such that a method of bringing an applied voltage to an on state at least two time instants as shown in FIG. 10 is adopted in addition to the dV/dt control method indicated in FIG. 9. In principle, the dV/dt control method is used in combination with a digital gray-scale display method in which a turn-on time is continuously controlled within one frame time, whereby tones represented by twelve bits or more can be reproduced for each color.

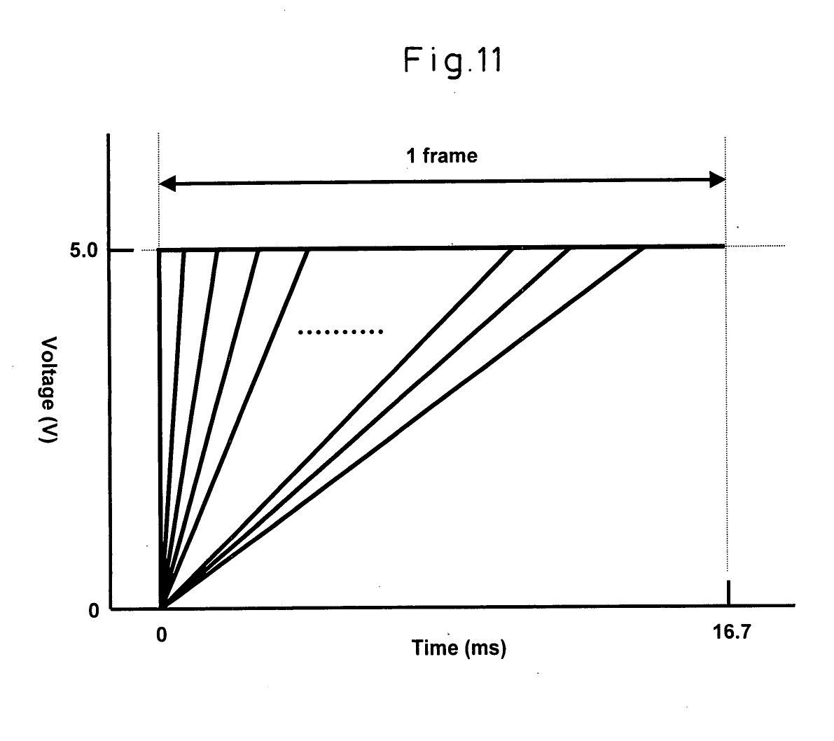

FIG. 11 is a conceptual diagram showing an optical response time of a PSS-LCD in which the dV/dt control method is implemented. As seen from FIG. 11, the electro-optical response characteristic of the PSS-LCD panel continuously changes along with the continuous change in the dV/dt value. This signifies that a cumulative quantity of light transmitted during one frame composed of the cumulated times changes continuously.

(Variant of the Novel Gray-Scale Display Method Implemented in a PSS-LCD)

According to a variant that is based on the same concept but adopts a different method of applying a voltage to an LCD panel, a plurality of different voltages is applied in combination during one frame in order to display successive shades. Namely, assuming that an LCD responds to an applied voltage sufficiently quickly for one frame time, a plurality of voltages exhibiting different crest values are applied in combination in order to realize a desired number of shades or gray-scale levels.

The concept of the gray-scale display method is that as long as an LCD responds to an applied voltage sufficiently quickly for a designated one frame time, a digital gray-scale display method of controlling a turn-on time continuously within the one frame time is used fundamentally. In addition, a rate at which an applied voltage is time-sequentially increased is continuously changed, the crest value of an applied voltage is changed, or voltages exhibiting different crest values are used in combination. Thus, multiple tones represented by ten bits or more can be displayed for each color. Consequently, the present display method can be adapted any LCD other than the PSS-LCD, as long as the LCD exhibits a satisfactory response time and an optical-response characteristic satisfactory for the rate at which an applied voltage is increased time-sequentially.

Hereinbelow, the present invention will be described in more detail with reference to specific examples.

### EXAMPLES

### Example 1

A glass substrate having a thickness of 0.7 mm and a size of 25 mm by 25 mm and having a transparent electrode thereof realized with an indium-tin-oxide (ITO) film whose area was 1 cm² was used to form a PSS-LCD panel. A voltage of 5 V having a pulse width of 1 ms was applied to the panel. The dV/dt value was changed in the range from 5V/ms to 20V/ms.

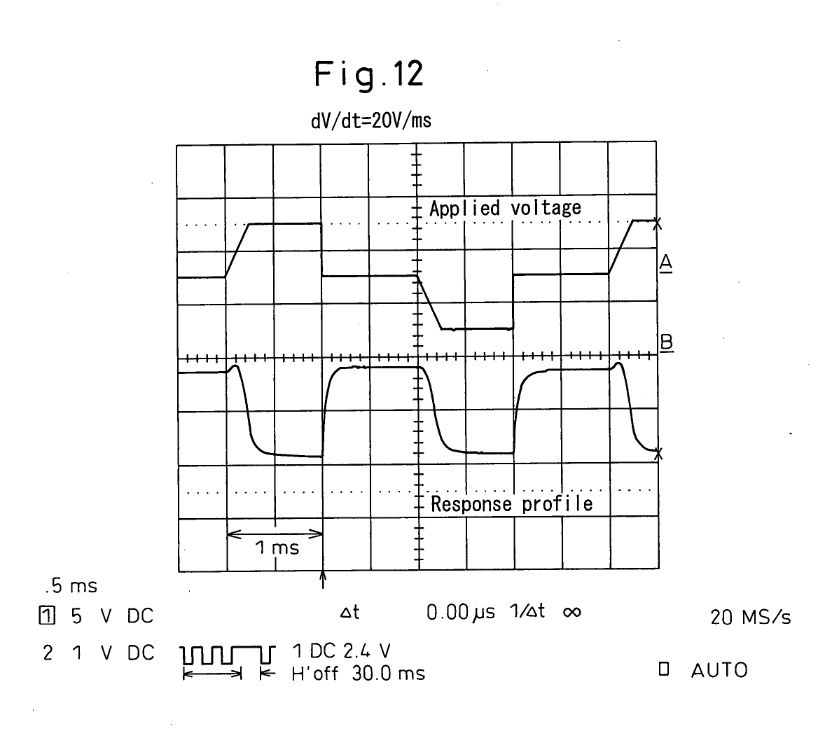

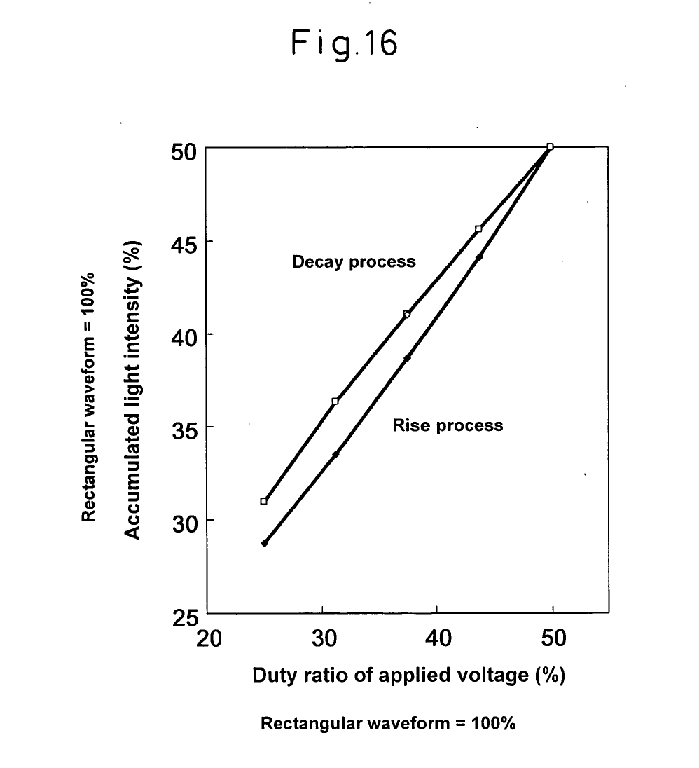

The time dependency (response characteristic) of the quantity of light transmitted by the PSS-LCD panel was measured in association with each dV/dt value. Consequently, as seen from FIG. 12 to FIG. 15, the response characteristic (indicated with a response profile) changes continuously along with a change in the dV/dt value. Moreover, as seen from FIG. 16 summarizing the graphs of FIG. 12 to FIG. 15, the response time attained when the dV/dt value was controlled continuously changes along with the change in the ratio of a cumulative amount of transmitted light from 27% to 50%. This signifies that tones represented by ten bits can be reproduced for each color.

The conditions for the measurements whose results are shown in FIG. 12 to FIG. 15 are listed below.

<Table 1>Conditions for the Measurement Whose Results are Shown in FIG. 12

TABLE 1
Conditions for Measurements, etc. in FIG. 12

24 Jun. 2004
14:17:58
A: Average (1)
0.5 ms
5.0 V
0 mV
77 swps
B: Average (2)
0.5 ms
1.00 V
0 mV
77 swps
TRIGGER SETUP
Edge SMART
trigger on
1 2 Ext Ext10
Line
coupling 1
DC AC LFREJ
HFREJ HF
slope 1
Pos Neg
Window
holdoff
30.0 ms
Off Time Evts

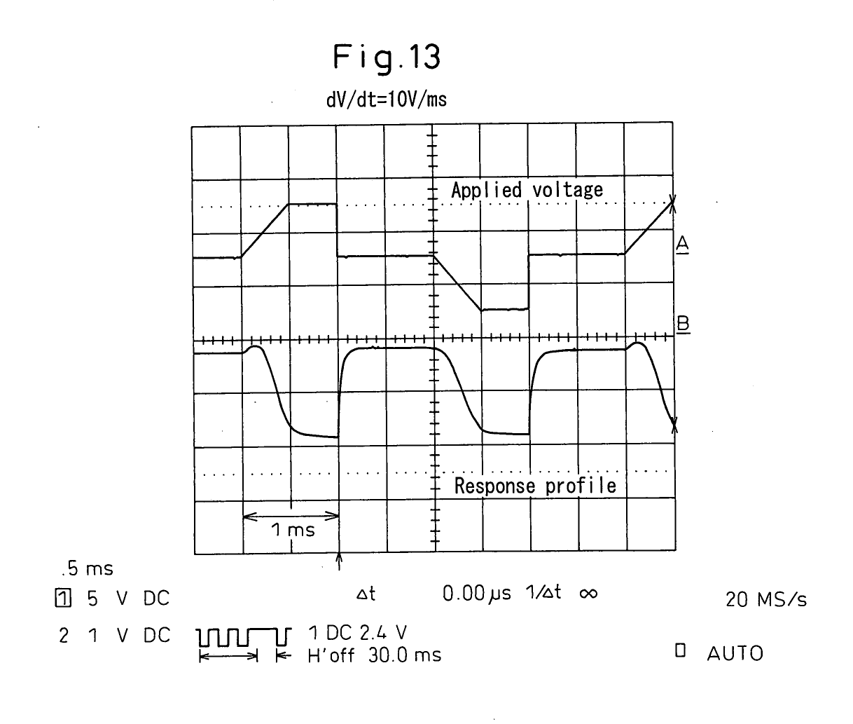

TABLE 2
Conditions for Measurements, etc. in FIG. 13

24 Jun. 2004
14:18:44
A: Average (1)
0.5 ms
5.0 V
0 mV
73 swps
B: Average (2)
0.5 ms
1.00 V
0 mV
73 swps
TRIGGER SETUP
Edge SMART
trigger on
1 2 Ext Ext10
Line
coupling 1
DC AC LFREJ
HFREJ HF
slope 1
Pos Neg
Window
holdoff
30.0 ms
Off Time Evts

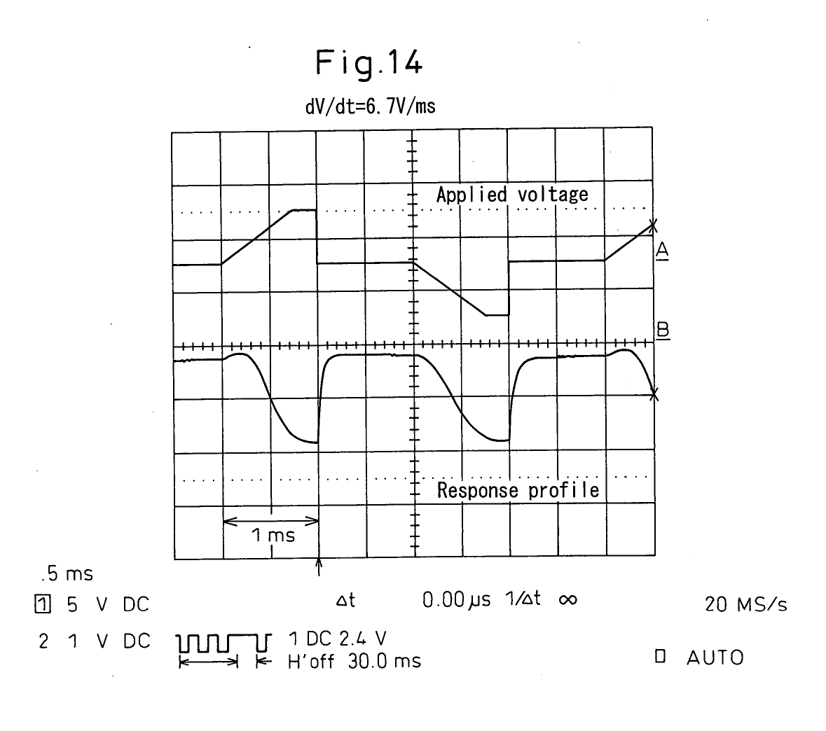

TABLE 3
Conditions for Measurements, etc. in FIG. 14

24 Jun. 2004
14:19:27
A: Average (1)
0.5 ms
5.0 V
0 mV
74 swps
B: Average (2)
0.5 ms
1.00 V
0 mV
74 swps
TRIGGER SETUP
Edge SMART
trigger on
1 2 Ext Ext10
Line
coupling 1
DC AC LFREJ
HFREJ HF
slope 1
Pos Neg
Window
holdoff
30.0 ms
Off Time Evts

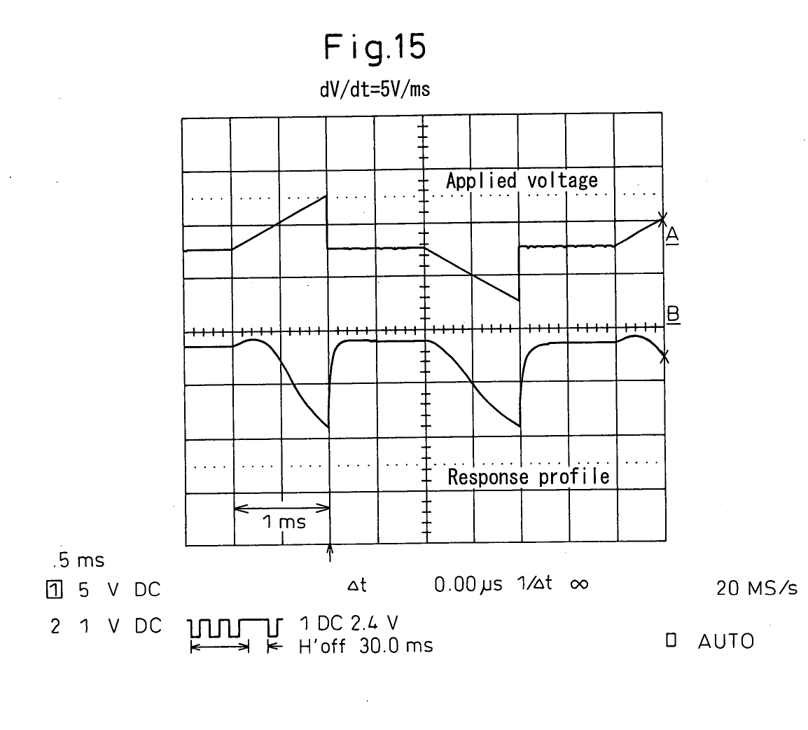

TABLE 4
Conditions for Measurements, etc. in FIG. 15

24 Jun. 2004
14:20:24
A: Average (1)
0.5 ms
5.0 V
0 mV
120 swps
B: Average (2)
0.5 ms
1.00 V
0 mV
120 swps
TRIGGER SETUP
Edge SMART
trigger on
1 2 Ext Ext10
Line
coupling 1
DC AC LFREJ
HFREJ HF
slope 1
Pos Neg
Window
holdoff
30.0 ms
Off Time Evts

### Example 2

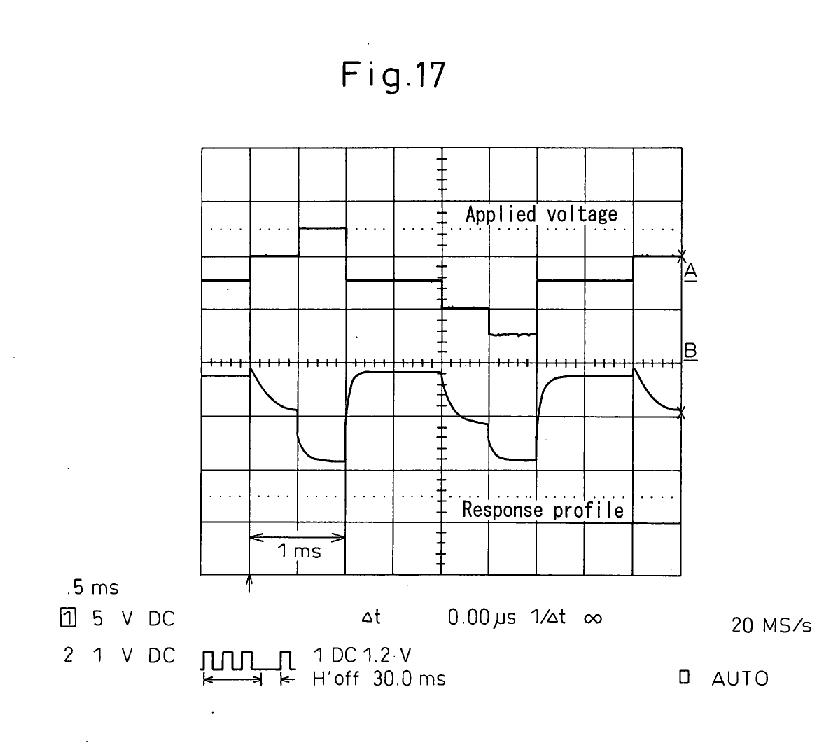

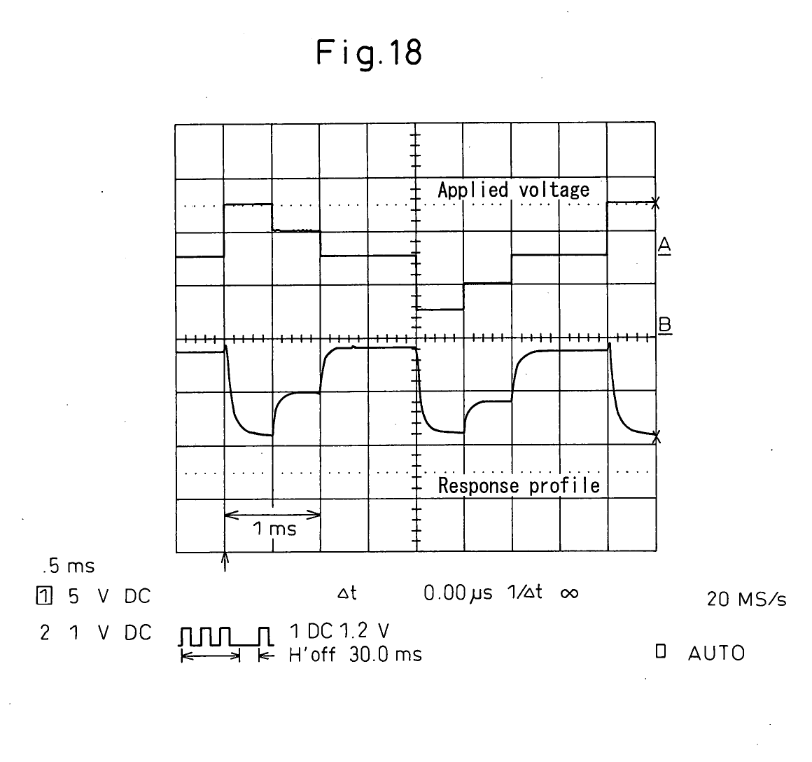

A glass substrate having a thickness of 0.7 mm and a size of 25 mm by 25 mm and having a transparent electrode realized with an ITO film whose area was 1 cm² was used to form a PSS-LCD. A voltage of 2.5 V having a pulse width of 0.5 ms and a voltage of 5 V having a pulse width of 0.5 ms are, as shown in FIG. 17 and FIG. 18, applied in combination to the panel.

The time dependency (response characteristic) of the quantity of light transmitted by the PSS-LCD panel was measured in association with the combination. Consequently, as shown in FIG. 17 and FIG. 18, the response characteristic of the PSS-LCD panel continuously changes along with a change in the combination of the crest values of the voltages. Moreover, the response time of the PSS-LCD panel that changes along with the change in the combination of the crest values of the applied voltages and that was associated with the ratio of a cumulative amount of transmitted light permits reproduction of tones, which are represented by ten bits, for each color.

From the invention thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a liquid crystal device comprising at least a pair of substrates and a liquid crystal material disposed between the pair of substrates,
wherein the quantity of light transmitted by the liquid crystal device is continuously controlled by changing the increasing rate of voltage in voltage pulse to be applied to the liquid crystal device with respect to time, to thereby attain gray-scale display.

2. The driving method according to claim 1, wherein the maximum quantity of light transmitted by the liquid crystal device within one frame is held constant, and the cumulative quantity of light transmitted by the liquid crystal device is continuously controlled by changing the increasing rate of voltage in voltage pulse to be applied to the liquid crystal device with respect to time, to thereby attain gray-scale display.

3. The driving method according to claim 1, wherein the light transmitted by the liquid crystal device is continuously controlled by changing crest voltage value of voltage pulse to be applied to the liquid crystal device with respect to time, to thereby attain gray-scale display.

4. The driving method according to claim 1, wherein the light transmitted by the liquid crystal device is continuously controlled by changing the combination of crest voltage values of voltage pulse to be applied to the liquid crystal device with respect to time, to thereby attain gray-scale display.

5. The driving method according to claim 1, wherein the light transmitted by the liquid crystal device is continuously controlled by changing both of the voltage increase rate and the combination of crest voltage values of voltage pulse to be applied to the liquid crystal device with respect to time, to thereby attain gray-scale display.

6. The driving method according to any of claims 1 to 6, wherein the liquid crystal device is a PSS-LCD.
